(19) United States
(12) Patent Application Publication
(10) Pub. No.: US 2013/0013490 A1
(43) Pub. Date: Jan. 10, 2013

(54) MOBILE APPARATUS WITH BACK-UP PAYMENT SYSTEM

(75) Inventors: Marc B. Keller, Charlotte, NC (US); David M. Grigg, ROCK HILL, SC (US)

(73) Assignee: BANK OF AMERICA CORPORATION, CHARLOTTE, NC (US)

(21) Appl. No.: 13/179,379

(22) Filed: Jul. 8, 2011

(51) Int. Cl. G06Q 40/00

(52) U.S. Cl. 705/39

(57) ABSTRACT

Embodiments of the invention are directed to apparatus, methods, and computer program products for allowing a user to make a payment at a payment terminal via a mobile device via a back-up payment module that is attached to the mobile device. In some embodiments, the back-up payment module allows a user to make a payment at a payment terminal by establishing physical contact between the back-up payment module and the payment terminal. In some embodiments, the back-up payment module allows a user to make a payment at a payment terminal when one or more other methods of making a payment via a mobile device are unavailable.

### BACKGROUND

A contactless payment is a payment where a customer pays a purchase amount without handing a payment card or a payment device to a cashier at the point-of-sale (POS) and without swiping the magnetic stripe of a payment card through a payment terminal (also sometimes referred to as a POS terminal). In other words, a contactless payment is one made using a payment device that wirelessly transmits payment information to the payment terminal. Although physical contact between the payment device and the payment terminal may still occur in a contactless payment environment, physical contact between the payment device and the payment terminal is not necessary for transmission of the payment information from the payment device to the payment terminal. A contact payment is a payment where physical contact between the payment device and the payment terminal is necessary for transmission of the payment information from the payment device to the payment terminal.

Many payment terminals currently have the ability to read and process electronic payment information such as credit card or debit card information received wirelessly from a mobile device (e.g., a cell phone or other handheld computer) that is brought close to the payment terminal. Mobile devices configured with contactless payment technology are often referred to as “mobile wallets” or “electronic wallets.”

A mobile device having mobile wallet capabilities may allow a user to use the mobile device's interface to select a payment vehicle that the user wishes to use for paying a purchase amount. Subsequently, the mobile device may transmit payment information associated with the selected payment vehicle when the mobile device is brought close to the payment terminal. As used herein, a payment vehicle may be a payment instrument such as a credit account, debit account, bank card, or other instrument that can be used by one entity to pay another entity.

A mobile device is typically powered by a power source, such as a battery or the like, that is present in the mobile device. This power source may allow a user to perform several functions associated with a mobile device, such as making a phone call, accessing a network, executing a mobile application, making a contactless payment at a payment terminal, etc.

Sometimes, a user may forget to carry a power source for a mobile device. At other times, a power source may not be slotted properly in the mobile device. At still other times, a power source may be faulty or discharged, and consequently, the power source may not be able to supply power to the various components or modules of the mobile device. At still other times, a mobile device may simply be turned “off,” and consequently, the power source may not be able to supply power to the various modules of the mobile device, including the mobile wallet module. In each of these situations, today's mobile devices may not allow a user to make a contactless payment at a payment terminal.

Without the ability to make a contactless payment at a payment terminal in each of these situations, a user who usually uses a mobile device for making a contactless payment is gravely inconvenienced. This may lead to the user having to carry other back-up payment devices in order to make a payment in each of the above situations. Moreover, a user who encounters some of the above situations more regularly than others, such as frequent travelers, may stop using their mobile device for making contactless payments altogether. Consequently, this problem with current mobile wallet technology may prevent widespread use and adoption of mobile wallets because people need to know that their payment devices are reliable.

Therefore, for all these reasons and others, there is a need for a system that may allow a user to make a contactless payment or a contact payment at a payment terminal in a situation where the primary power source in a mobile device is not present or not active, or in a situation where one or more methods of making a payment may not be available.

### BRIEF SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Embodiments of the present invention address the above needs and/or achieve other advantages by providing an apparatus (e.g., a system, computer program product, and/or other device), method, or a combination of the foregoing for making a payment at a payment terminal via a mobile device regardless of whether a power source in a mobile device is present or active. An active module of a mobile device may enable a user to make a contactless payment via a mobile device when a power source in a mobile device is both present and active. A passive module of a mobile device may enable a user to make a contactless payment via a mobile device when a power source in a mobile device is either not present or not active. A back-up payment module, which in one embodiment is a contact payment module, may enable a user to make a payment via a mobile device by establishing physical contact with a payment terminal, regardless of whether a power source in a mobile device is present or active. A code payment module may enable a user to make a payment via a mobile device by allowing a payment terminal to scan a code, such as a barcode, associated with a mobile device. This payment module may be useful when one or more other methods of making a payment are unavailable.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a flow chart illustrating an “active” method of making a payment via an active module of a mobile device and a “passive” method of making a payment via a passive module of a mobile device;

FIG. 2 provides a look-up table that comprises payment vehicle data associated with each payment vehicle, including the default payment vehicle, in a mobile wallet;

FIG. 3 provides a block diagram illustrating a contactless payment environment, in accordance with an embodiment of the invention;

FIG. 4 provides a block diagram illustrating the mobile device of FIG. 3, in accordance with an embodiment of the invention;

FIG. 5 provides a block diagram illustrating the mobile device of FIG. 3, in accordance with another embodiment of the invention;

FIG. 6 provides a block diagram illustrating the mobile device of FIG. 3, in accordance with another embodiment of the invention;

FIG. 7 provides a block diagram illustrating the payment terminal of FIG. 3, in accordance with another embodiment of the invention; and

FIGS. 8-28 provide block diagrams illustrating the mobile device of FIG. 3 that comprises a back-up payment module, in accordance with other embodiments of the invention;

FIG. 29 provides a block diagram illustrating the contact payment terminal of FIG. 3, in accordance with another embodiment of the invention; and

FIG. 30 provides a block diagram illustrating the code payment terminal of FIG. 3, in accordance with another embodiment of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

In accordance with embodiments of the invention, the term “entity” may refer to a seller, merchant, or the like, that offers contactless payment as a method of paying for a purchase associated with the entity. In accordance with embodiments of the invention, the term “user” may refer to a customer or the like, who makes a payment at a payment terminal associated with an entity. In accordance with embodiments of the invention, the term “tapping” may refer to bringing a mobile device close to or within the proximity of a payment terminal so that information can be communicated wirelessly between the mobile device and the payment terminal using short range wireless transmission technology, such near-field communication (NFC) technology, radio-frequency (RF) technology, or the like. Tapping may include physically tapping the mobile device against an appropriate portion of the payment terminal or it may include waving or holding the mobile device near an appropriate portion of the payment terminal without making physical contact with the payment terminal. In accordance with embodiments of the invention, the term “payment vehicle” may refer to an electronic payment vehicle, such as an electronic credit or debit card. The payment vehicle may not be a “card” at all and may instead be account identifying information stored electronically in a mobile device, such as in a mobile telephone. In accordance with embodiments of the invention, the term “module” with respect to a mobile device may refer to a hardware component of a mobile device, a software component of a mobile device, or a component of a mobile device that comprises both hardware and software. In accordance with embodiments of the invention, the term “chip” may refer to an integrated circuit, a microprocessor, a system-on-a-chip, a microcontroller, or the like that may either be integrated into the mobile device or may be insertable and removable from the mobile device by a user. In accordance with embodiments of the invention, the phrase “mobile wallet” refers to the hardware and/or software in a mobile device that enables the mobile device to be used to make contactless payments at a payment terminal.

In general, embodiments of the present invention relate to systems, methods and computer program products for making a payment at a payment terminal via a mobile device regardless of whether the primary power source in a mobile device is present or active. One embodiment of the invention enables a user to make a contactless payment at a payment terminal regardless of whether the user is able to access a mobile wallet application installed on the user's mobile device, where the mobile wallet application is configured to allow a user to wirelessly communicate payment information to a payment terminal.

The mobile wallet application is configured to help the user manage payment information stored on the mobile device and help the user to communicate payment information to the payment terminal using the correct protocol or data format. The mobile wallet application, when executed by the processor of the mobile device, typically presents the user with a graphical user interface (GUI) that allows the user to select a payment vehicle to use for a transaction from a plurality of payment vehicles stored in the mobile device, or in a mobile wallet chip that may be integrated into the mobile device. The GUI may also allow the user to set certain payment preferences or mobile wallet preferences.

In one embodiment of the invention, the user's mobile device may comprise an active module and a passive module. In one embodiment, both the active and passive modules may be integrated into a chip that may be integrated into a mobile device.

The active module may enable a user to make a contactless payment at a payment terminal when a power source in a mobile device is present and active. A power source in a mobile device may be present when the power source is properly slotted into the mobile device. A power source in a mobile device may be active when the power source is able to supply power to the active module. The power source that supplies power to the active module may also supply power to other components of the mobile device. In one embodiment, the power source that supplies power to the active module may be the only power source in the mobile device. When the power source that supplies power to the active module in a mobile device is both present and active, the user may select a payment vehicle via the mobile wallet application described above. Subsequently, the mobile device may transmit payment vehicle data of the selected payment vehicle from the mobile device to a payment terminal, wherein the power for making this transmission is supplied by a power source in the mobile device. The power source that supplies power for making this transmission may either be the same power source or a different power source from the power source that supplies power to the active module in a mobile device.

The passive module may enable a user to make a contactless payment at a payment terminal when the power source that supplies power to the active module in a mobile device is either not present or not active. A power source in a mobile device may not be present when it is either missing from the mobile device or improperly slotted into the mobile device. In one embodiment, a power source that supplies power to an active module in a mobile device may not be active when the power source is unable to supply power to the active module. In one embodiment, a power source that supplies power to the active module may not be active when the power source is unable to supply power to the active module, regardless of whether it is able to supply power to other components of the mobile device. In one embodiment, a power source that supplies power to the active module may not be active when it is unable to supply power to the active module, regardless of whether other power sources in the mobile device are able to supply power to other components of the mobile device. The power source that supplies power to the active module may be unable to supply power when the power source is faulty, when the power source is discharged, when the mobile device is turned “off,” when the mobile device is dead, or the like.

When the power source that supplies power to the active module in a mobile device is either not present or not active, the passive module of the mobile device may allow a contactless payment via a default payment vehicle that is stored in the mobile device, or in a chip that is integrated into the mobile device. In one embodiment, the passive module may allow a user to make a contactless payment when all power sources in a mobile device that supply power to the active module in the mobile device are either not present or not active. The mobile device may transmit payment vehicle data associated with the default payment vehicle from the mobile device to a payment terminal, wherein the power for making this transmission may be supplied by an external source, such as the payment terminal or the like. In one embodiment, an electromagnetic field of the payment terminal may supply the power for making the transmission. Therefore, in one embodiment, there is no power source in the mobile device that may supply power to the passive module for making the transmission.

Therefore, the invention may permit a user to make a contactless payment via a mobile device even when a power source in the mobile device is not present or active. The invention may also permit a user to make a contact payment via a mobile device, regardless of whether a power source in a mobile device is present or active.

### Contactless Payment Process Flow

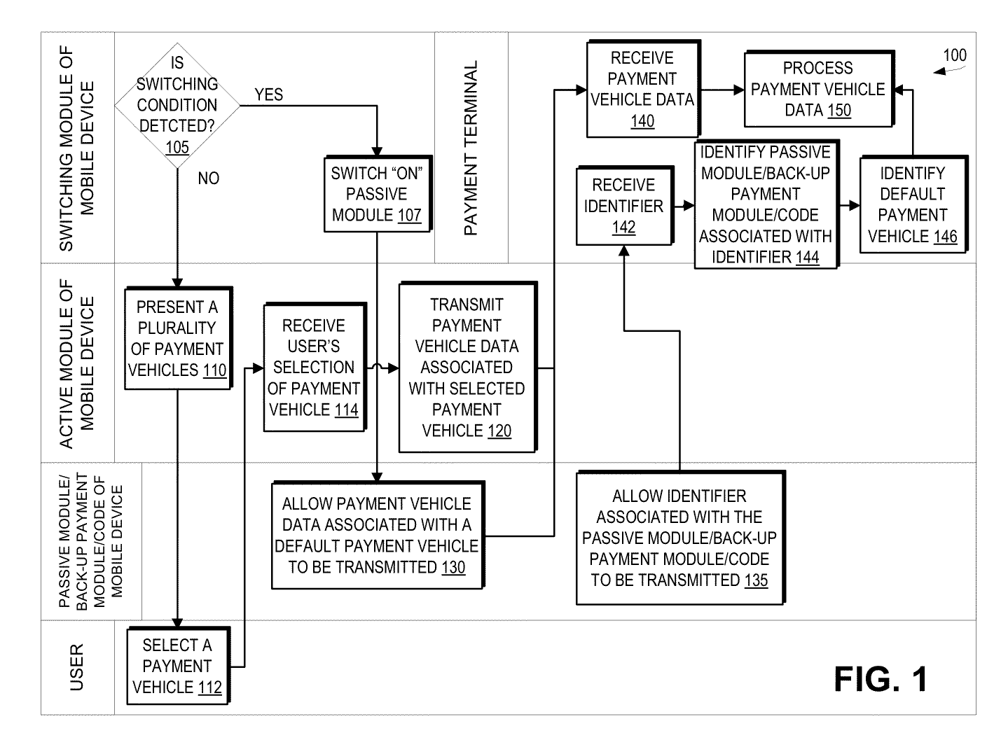

FIG. 1 provides a flow chart illustrating a process 100 for making a payment using either an active or passive module of a mobile device, in accordance with an embodiment of the invention. FIG. 1 illustrates the flow chart in terms of “swim lanes” associated with entities which may perform the operations in each respective swim lane. The entities illustrated in the figure are (1) a payment terminal, (2) a switching module of a mobile device, (3) an active module of a mobile device, (4) a passive module of a mobile device, and (5) a user of a mobile device. However, it should be noted that other entities could also be involved and some embodiments of the invention may not be limited to the entities illustrated in FIG. 1. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

### Switching Condition Detection Routine and Switching Routine

In one embodiment, a mobile device may comprise a switching module. As explained in a later section, this switching module may be part of or integrated into a chip. In one embodiment, the chip is a mobile wallet chip. In some embodiments, the mobile wallet chip is integrated into the mobile device. In other embodiments, the mobile wallet chip may be insertable and removable from the mobile device by a user. In one embodiment, the switching module is separate from the mobile wallet chip. In one embodiment, the switching module may monitor the presence or absence of one or more switching conditions and execute a switching routine as described below. In some embodiments, other modules in the mobile device may execute the processes performed by the switching module.

A switching module may constantly monitor the presence or absence of one or more switching conditions at block 105 of FIG. 1. In one embodiment, a switching module may be able to monitor the presence or absence of one or more switching conditions as long as a power source in a mobile device supplies power to the switching module. The power source that supplies power to the switching module may be the same power source that supplies power to the active module of a mobile device. In one embodiment, a switching module may be a mechanical switching module that does not depend on a power source in a mobile device. In such an embodiment, the switching module may be able to constantly monitor the presence or absence of one or more switching conditions regardless of whether there is a power source in the mobile device.

In one embodiment, a switching condition may be satisfied when a power source that supplies power to an active module of the mobile device is either not present or not active.

In another embodiment, a switching condition may be satisfied when the power remaining in a power source that supplies power to an active module of the mobile device drops below a pre-determined threshold. In some embodiments, this pre-determined threshold may be set by a user of the mobile device. In some embodiments, this pre-determined threshold may be 1%. In such embodiments, the switching module may turn “off” the active module and turn “on” the passive module. In such an embodiment, if the switching module does not turn “off” the active module, the mobile device may be able to transmit payment vehicle data via both the active and passive modules until the power source that supplies power to the active module of the mobile device is discharged completely. In some embodiments, the switching module may be configured to use an interface of the mobile device to ask a user whether the user wants to activate the passive module and deactivate the active module. Therefore, in some embodiments, a user may respond that the user wants to switch from the active module to the passive module, and consequently, the switching module may turn “off” the active module and turn “on” the passive module. In some embodiments, the user may respond that the user does not want to switch from the active module to the passive module. In such embodiments, the user may continue to access the active module until the power source that supplies power to the active module is discharged completely, and once that power source is discharged completely, the passive module may turn “on” automatically, while the active module may turn “off” automatically.

In another embodiment, a switching condition may be satisfied when an active module is either not present or is dysfunctional. In an embodiment where the active module is dysfunctional, the switching module may turn “off” the active module so that the active module does not interfere with any processes performed by the passive module.

The switching conditions provided above are merely examples of some switching conditions. The number or type of switching conditions may not be limited to the conditions described above.

Turning a module “on” as described in various embodiments may comprise closing or making a circuit that supplies power from one or more power sources to the module. Turning a module “on” may also be referred to as activating a module. Therefore, a module that is “on” is active. Turning a module “off” as described in various embodiments may comprise opening or breaking a circuit that supplies power from one or more power sources to the module. Turning a module “off” may also be referred to as deactivating a module. Therefore, a module that is “off” is not active.

In one embodiment, a passive module may always be “off” unless a switching condition is detected by a switching module. If the switching module detects a switching condition at block 105, the process moves to block 107, where the switching module may execute a switching routine. In one embodiment, the switching routine may comprise the switching module turning “on” the passive module. In another embodiment, some other module or component of the mobile device may turn “on” the passive module once the switching module detects a switching condition. In another embodiment, the passive module may turn itself “on” once the switching module detects a switching condition. In another embodiment, the active module may turn “on” the passive module once the switching module detects a switching condition. In one embodiment, the switching routine may comprise the switching module turning “off” the active module. In another embodiment, some other module or component of the mobile device may turn “off” the active module once the switching module detects a switching condition that requires the active module to be turned “off.” In another embodiment, the active module may turn itself “off” once the switching module detects a switching condition. In another embodiment, the passive module may turn “off” the active module once the switching module detects a switching condition that requires the active module to be turned “off.”

In one embodiment, the switching module or some other module in the mobile device may detect that the switching condition which had previously been detected is no longer detected or satisfied. The switching conditions have been described previously. In such a situation, the switching module may execute a second switching routine. In one embodiment, the second switching routine may comprise the switching module turning “off” the passive module. In another embodiment, some other module or component of the mobile device may turn “off” the passive module once the switching module detects that the switching condition is no longer detected or satisfied. In another embodiment, the passive module may turn itself “off” once the switching module detects that the switching condition is no longer detected or satisfied. In another embodiment, the active module may turn “off” the passive module once the switching module detects that the switching condition is no longer detected or satisfied. In one embodiment, the second switching routine may comprise the switching module turning “on” the active module. In another embodiment, some other module or component of the mobile device may turn “on” the active module once the switching module detects that the switching condition is no longer detected or satisfied. In another embodiment, the active module may turn itself “on” once the switching module detects that the switching condition is no longer detected or satisfied. In another embodiment, the passive module may turn “on” the active module once the switching module detects that the switching condition is no longer detected or satisfied.

### Active Payment Routine

In one embodiment, a mobile device may comprise an active module. As explained in a later section, this active module may be part of or integrated into a chip. In one embodiment, the chip is a mobile wallet chip. In some embodiments, the mobile wallet chip is integrated into the mobile device. In other embodiments, the mobile wallet chip may be insertable and removable from the mobile device by a user. In one embodiment, the active module executes an active payment routine as described below.

In one embodiment, the active payment routine is executed by the active module when a power source is both present and active. In one embodiment, a power source in a mobile device may be present when the power source is properly slotted into the mobile device. In one embodiment, a power source in a mobile device may be active when the power source is able to supply power to the active module. The power source that supplies power to the active module may also supply power to other components of the mobile device.

The process begins at block 110 of FIG. 1 where the mobile device may present a plurality of payment vehicles to the user. In one embodiment, a user may have previously entered information for each payment vehicle and may have directed the mobile device to store the information either locally on the mobile device or at a remote server. In one embodiment, the locally stored payment vehicles are stored in a secure module, where the secure module may be stored in the mobile wallet chip. Therefore, the mobile device may either present these locally stored payment vehicles or may dynamically access the payment vehicles from a remote server and present them to the user. In one embodiment, the mobile device may also present an option for a user to enter information for a new payment vehicle.

The process moves to block 112 of FIG. 1 where the user may select a payment vehicle. For instance, in one embodiment, the user may select “Credit Card 1” as the payment vehicle. In one embodiment, a user may also select a gift card as the payment vehicle. In another embodiment, the user may select multiple payment vehicles and the percentage amount of the payment amount or an absolute amount to be paid from each payment vehicle.

The process then moves to block 114 where the mobile device may receive the user's selection of one or more payment vehicles. In one embodiment, the mobile device may automatically select one or more payment vehicles without presenting the one or more payment vehicles to the user and without allowing the user to select a payment vehicle. The process of automatically selecting a payment vehicle by a mobile device may be based on a pre-determined algorithm that takes into account various parameters including the place of purchase, the type of purchase, the amount of the purchase, the type of payment vehicle selected, the payment vehicle's balance, whether the payment vehicle may be used at the place of purchase, whether the payment vehicle has been used previously at the place of purchase, whether using the payment vehicle would result in earning reward points, whether using the payment vehicle would result in achieving a discount on the purchase price, whether using the payment vehicle would result in a rebate, or the like. The algorithm may be coded into a software program that may be executed by a mobile wallet application. In other embodiments, the place of purchase, type of purchase, the purchase amount, etc. may be determined when the mobile device interacts with the payment terminal, as described below, when the mobile device is tapped at or held close to the payment terminal. In another embodiment, the user may enter input into the mobile device to indicate to the mobile device the type of purchase, place of purchase, purchase amount, etc. For instance, the user may input into the mobile device the entity from which the user made a purchase (e.g., fast food restaurant) along with the type of purchase (e.g., cheeseburger meal), etc., and subsequently, the mobile device may automatically select the one or more payment vehicles based on this input.

The process then moves to block 120 where the mobile device may transmit the payment vehicle data as part of a payment vehicle data packet to the payment terminal. The mobile device must transmit data to the payment terminal in a format that is readable and processable by the payment terminal; otherwise, the user may not be able to make a contactless payment via a mobile device. The mobile device may transmit the payment vehicle data packet via any of a number of near field communication techniques.

In one embodiment, the mobile device may transmit data packets via near field communication (NFC). NFC transmission may comprise radio frequency electromagnetic waves emanating from the mobile device's transmitting antenna when the mobile device is tapped at or held or waved in close proximity to the payment terminal. When the mobile device's transmitting antenna and the payment terminal's receiving antenna are located in each other's electromagnetic field, they effectively form a transformer and data packets may be transmitted from the mobile device to the payment terminal via electromagnetic induction. Alternatively, data packets may also be transmitted from the payment terminal's transmitting antenna to the mobile device's receiving antenna when both antennas are located in each other's near electromagnetic field. In one embodiment, the near electromagnetic field for an antenna may approximately be a distance measured from the antenna up to a single wavelength distance from the antenna. In one embodiment, the transmitting and receiving antennas of the mobile device may be the same antenna. In one embodiment, the transmitting and receiving antennas of the payment terminal may be the same antenna.

In one embodiment, an encryption module at the mobile device may encrypt the data packets prior to the mobile device transmitting the data packets to the payment terminal. Encryption permits data packets to be securely transmitted to the payment terminal such that the encrypted data packets may only be decrypted by the payment terminal. In such an embodiment, the data packets may need to be decrypted by a decryption module at the payment terminal when the data packets are received at the payment terminal.

In one embodiment, the ISO/IEC 14443 standard may define the protocol associated with wirelessly transmitting data packets from the mobile device to the payment terminal. However, in other embodiments, other standards may be utilized.

In one embodiment, the mobile device may transmit to or receive data packets from the contactless payment terminal in the radio frequency band of 13.56 MHz. In other embodiments, other frequency bands of the electromagnetic spectrum may be used to transmit or receive data packets. In one embodiment, the mobile device may transmit to or receive data packets from a contactless payment terminal situated within a distance of up to 25 cm. In other embodiments, the mobile device may transmit to or receive data packets from a contactless payment terminal situated at a distance greater than 25 cm.

In one embodiment, a power source in the mobile device may provide the power required to initiate a transmission of data packets via radio frequency electromagnetic waves once the transmitting antenna of the mobile device identifies the presence of the receiving antenna at the payment terminal.

In one embodiment, a user may turn “off” the transmitting antenna of the mobile device so that even when the mobile device is tapped at or held close to the payment terminal, data packets are not transmitted from the mobile device to the payment terminal. In another embodiment, the transmitting antenna of the mobile device may always be “on” and the user may not be able to turn “off” the transmitting antenna of the mobile device.

### Passive Payment Routine

In one embodiment, a mobile device may comprise a passive module. As explained in a later section, in some embodiments, this passive module may be part of or integrated into the same mobile wallet chip that comprises the active module. In other embodiments, the passive module may be part of or integrated into a mobile wallet chip that is distinct from the mobile wallet chip that comprises the active module. If the passive module is carried on a separate mobile wallet chip from the mobile wallet chip that comprises the active module, this separate mobile wallet chip may either be integrated into the mobile device or it may be insertable and removable from the mobile device by a user.

In one embodiment, the passive payment routine is executed by the passive module when a power source in a mobile device is not present or active. A power source in a mobile device may not be present when it is either missing or improperly slotted into the mobile device. In one embodiment, a power source in a mobile device may not be active when it is unable to supply power to the active module. In one embodiment, a power source in a mobile device may not be active when it is unable to supply power to the active module, regardless of whether it is able to supply power to other components of the mobile device. The power source may be unable to supply power when the power source is faulty, when the power source is discharged, when the mobile device is turned “off,” when the mobile device is dead, or the like.

In one embodiment, the mobile device may, at block 130 of FIG. 1, allow payment vehicle data associated with a default payment vehicle to be transmitted when a user taps or holds or waves the user's mobile device in close proximity to the payment terminal. The payment vehicle data is transmitted from the mobile device to the payment terminal according to the embodiments described above with respect to the active payment routine. However, rather than a power source in the mobile device providing the power to initiate the transmission, a payment terminal, or some other external power source, may produce an external electromagnetic field that provides the power to allow the mobile device's transmitting antenna to initiate a transmission, via radio frequency electromagnetic waves, of payment vehicle data associated with the default payment vehicle.

In one embodiment, a user may not be able to change the payment vehicle that is designated as the default payment vehicle. However, as explained below, in other embodiments, a user may be able to change the payment vehicle that is designated as the default payment vehicle.

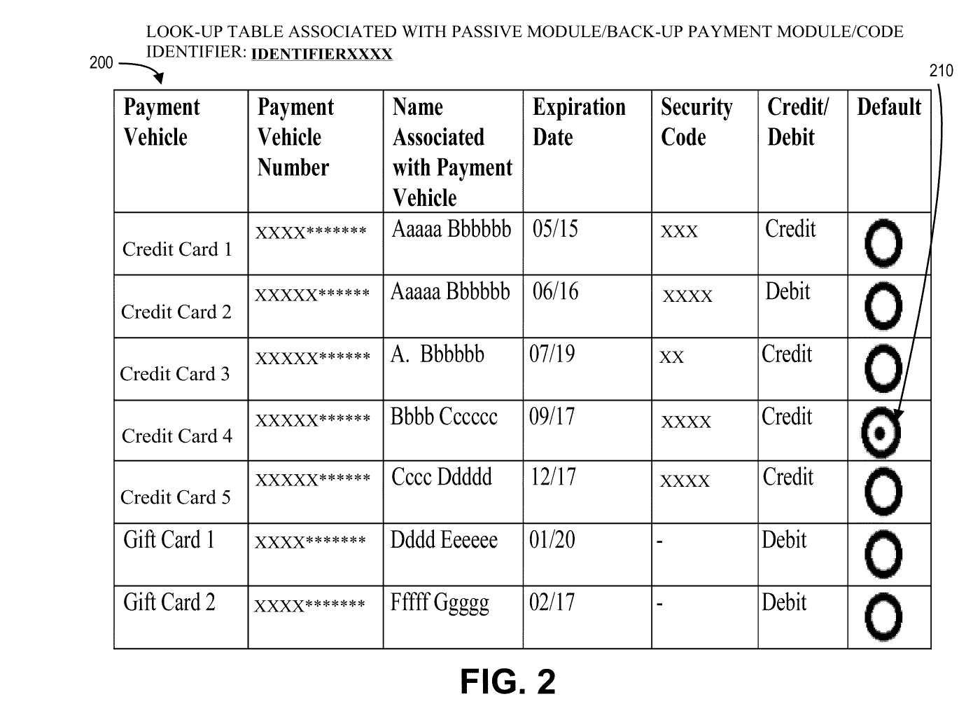

FIG. 2 displays an illustration of a look-up table 200 that is associated with the mobile wallet chip. In some embodiments, this look-up table is stored in a mobile wallet chip, and more particularly, in a secure module of a mobile wallet chip. As displayed in FIG. 2, the look-up table comprises payment vehicle data regarding each payment vehicle that may be used at a payment terminal. The payment vehicle data for each payment vehicle may include the payment vehicle type, the payment vehicle number, the name associated with the payment vehicle, the expiration date of the payment vehicle, the security code associated with the payment vehicle, whether the payment vehicle is a credit or debit payment vehicle, etc. Also as displayed in FIG. 2, the look-up table may indicate the payment vehicle that has been selected as the default payment vehicle 210. Also as displayed in FIG. 2, in some embodiments, there may only be a single default payment vehicle that may be selected by the user. In one embodiment, there may more than one default payment vehicle that may be selected by the user. In another embodiment, a user may establish a hierarchy of payment vehicles to serve as the default payment vehicle. In such an embodiment, the user may establish a ranking for the payment vehicles in the look-up table. In such an embodiment, the highest ranked payment vehicle may serve as the default payment vehicle when the passive module of the mobile device executes a passive payment routine.

In an embodiment where the user may be allowed to change the payment vehicle that is designated as the default payment vehicle, the user may select a radio button, or the like, for a different payment vehicle in order to change the default payment vehicle. In one embodiment where the look-up table is stored in a secure module of a mobile wallet chip, the look-up table may be accessed via the user's mobile device's mobile wallet application GUI while a power source in the mobile device is present and active. When the user changes the default payment vehicle, the change is directly made in the look-up table that may be stored in a secure module in the mobile wallet chip.

In one embodiment, the above described look-up table may not be stored in a secure module of the mobile wallet chip. In this embodiment, the look-up table is stored in a remote server and may be accessed via a network such as the Internet on a personal computer, a mobile device, some other computing platform or the like. Therefore, in this embodiment, the look-up table need not be accessed via the mobile device that comprises the mobile wallet chip. In this embodiment, when the user changes the default payment vehicle, the change is directly made in the look-up table that is stored at the remote server.

In an embodiment where the look-up table is stored in a remote server, in lieu of allowing payment vehicle data associated with the default payment vehicle to be transmitted, the mobile device may, at block 135 of FIG. 1, allow an identifier or the like, associated with the passive module, to be transmitted when the user taps or holds or waves the mobile device in close proximity to the payment terminal. In an embodiment where the passive module is an RFID tag or sticker, this identifier is a unique identifier that identifies the passive module that is stored in the user's mobile device. This unique identifier is also associated with the look-up table that is stored in a remote server. In one embodiment the identifier is a numeric code, alphanumeric code, hexadecimal code, binary code, or the like.

### Receipt of Payment Vehicle Data

In an embodiment where the payment terminal receives a payment vehicle data packet, the process then moves to block 140 of FIG. 1 where the payment terminal may receive a payment vehicle data packet from the user's mobile device. In one embodiment, the payment terminal may indicate that it has received the payment vehicle data packet by producing an audible beep. In another embodiment, the payment terminal may indicate that it has received the payment vehicle data packet by changing the color associated with one or more light emitting diodes (LEDs) that are situated on the payment terminal or by switching one or more LEDs from an “off” state to an “on” state. The method by which the payment terminal may indicate that it has received the payment vehicle data packet is not limited to these embodiments. In one embodiment, the payment terminal may not indicate, at all, that it has received the payment vehicle data packet.

Subsequently, in one embodiment, the payment terminal may identify the payment vehicle data packet by identifying the protocol associated with the payment vehicle data packet. For instance, if the received payment vehicle data packet protocol is identified as “ExpressPay” protocol, the received payment vehicle data is “Credit Card 1” payment vehicle data. If the received payment vehicle data packet protocol is identified as “payWave” protocol, the received payment vehicle data is “Credit Card 2” payment vehicle data. If the received payment vehicle data packet protocol is identified as “PayPass” protocol, the received payment vehicle data is “Credit Card 3” payment vehicle data. If the received payment vehicle data packet protocol is identified as “MIFARE” protocol, the received payment vehicle data may be gift card data.

Subsequently, the payment terminal may determine whether the payment vehicle data constitutes a valid payment vehicle. The rules that define whether the payment vehicle data constitutes a valid payment vehicle may be set by the entity from which the user makes a purchase. For instance, the algorithm that defines the payment vehicle validation process may comprise determining whether the payment vehicle has expired, whether the payment vehicle is accepted by the entity, whether the payment vehicle may be used for this purchase, or the like.

If the payment terminal determines that the payment vehicle data is not valid, the payment terminal may generate and present a message to the user. In an embodiment, the payment terminal may also present the reason why the payment vehicle is not an accepted form of payment. In an embodiment, the payment terminal may also allow the user to attempt the transaction with another payment vehicle.

### Receipt of Identifier Associated with Passive Module

In an embodiment where the mobile device transmits an identifier associated with the passive module rather than a payment vehicle data packet, the process moves from block 135 to block 142 of FIG. 1 where the payment terminal may receive an identifier associated with the passive module. In one embodiment, the mobile device may transmit the identifier in a data packet that is readable and processable by the payment terminal. For the data packet to be readable and processable by the payment terminal, the data packet must be associated with a data protocol that is readable and processable by the payment terminal.

In one embodiment, the payment terminal may indicate that it has received the identifier by producing an audible beep. In another embodiment, the payment terminal may indicate that it has received the identifier by changing the color associated with one or more light emitting diodes (LEDs) that are situated on the payment terminal or by switching one or more LEDs from an “off” state to an “on” state. The method by which the payment terminal may indicate that it has received the identifier is not limited to these embodiments. In one embodiment, the payment terminal may not indicate, at all, that it has received the identifier.

Subsequently, in one embodiment, the payment terminal may, at block 144 of FIG. 1, identify the passive module associated with the identifier by accessing a table of identifiers. Subsequently, the payment terminal may access the look-up table associated with the identified passive module. Subsequently, the payment terminal may, at block 146 of FIG. 1, identify from the look-up table the default payment vehicle selected by the user by accessing the previously described look-up table that is stored in a remote server.

Subsequently, the payment terminal may determine whether the payment vehicle data constitutes a valid payment vehicle. The rules that define whether the payment vehicle data constitutes a valid payment vehicle may be set by the entity from which the user makes a purchase. For instance, the algorithm that defines the payment vehicle validation process may comprise determining whether the payment vehicle has expired, whether the payment vehicle is accepted by the entity, whether the payment vehicle may be used for this purchase, or the like.

If the payment terminal determines that the payment vehicle data is not valid, the payment terminal may generate and present, via a display, a message to the user. In an embodiment, the payment terminal may also present, via a display, the reason why the payment vehicle is not an accepted form of payment. In an embodiment, the payment terminal may ask the user, via a display, whether the user would like to complete the transaction with another payment vehicle that is in the look-up table which is stored in a remote server. Subsequently, the payment terminal via allow the user to select, via a display associated with the payment terminal, an alternate payment vehicle that is stored in the look-up table.

### Processing of Payment Vehicle Data

If the payment terminal determines that the identified payment vehicle data is valid, the payment terminal may process the payment vehicle data at block 150 of FIG. 1. In one embodiment, processing the payment vehicle data may comprise transmitting the payment vehicle data to a processing system from where the payment vehicle data may be routed to the entity's processing financial institution for authorization of payment vehicle data, capture of electronic funds from the source authorized by the payment vehicle, and deposit of electronic funds into a destination account specified by the entity. In some embodiments, the processing system may prompt the payment terminal to request the user to authorize payment via the payment vehicle, e.g., requesting the user for a digital signature on a touchpad associated with the payment terminal, on an electronic receipt, on a paper receipt, or the like. In some embodiments, the processing system may prompt the payment terminal to request the user to authorize payment via the payment vehicle if the payment amount is above a certain threshold amount.

### Payment System and Environment

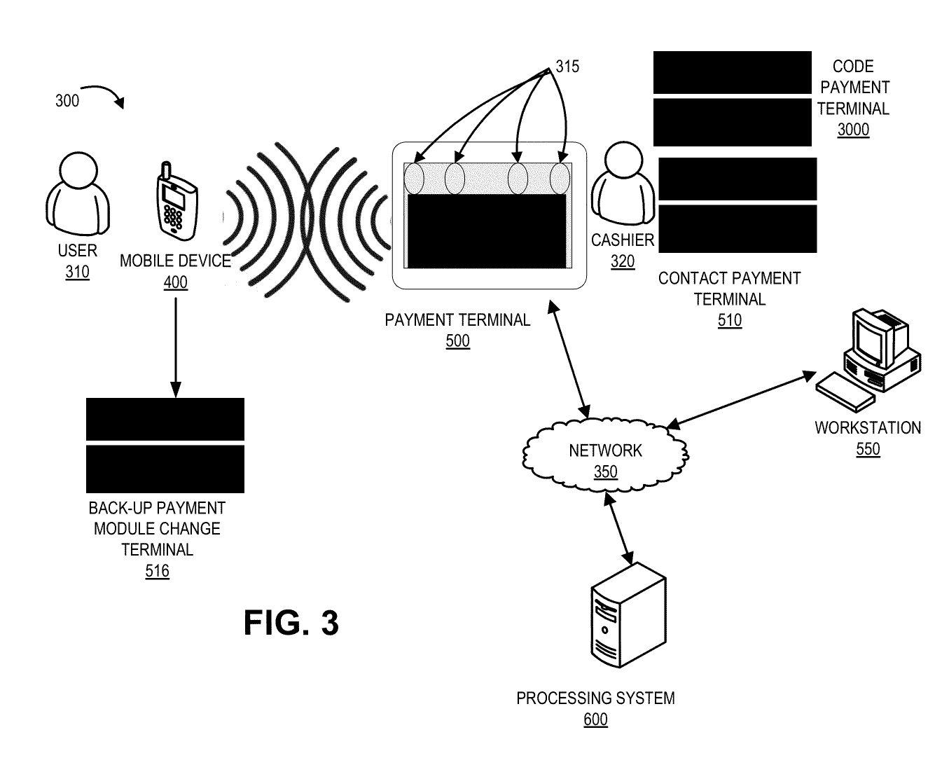

FIG. 3 provides a block diagram illustrating a contactless payment environment 300 configured for making a contactless payment via a mobile device, in accordance with an embodiment of the invention. As illustrated in FIG. 3, the contactless payment environment may include a mobile device 400 operable by a user 310 who may be a customer who wants to make a contactless payment via a mobile device. The contactless payment environment may also include a payment terminal 500 that may be automated or may be operable by a cashier 320. The payment terminal may permit a user to make a contactless payment with a payment device such as the mobile device 400.

In some embodiments, the environment 300 may also include a contact payment terminal 510 that may permit a user to make a payment via a contact payment device such as a payment card that has a magnetic stripe which may be swiped through the contact payment terminal 510. The contact payment terminal 510 may also permit a user to make a payment via a back-up payment module of a mobile device. The environment 300 may also include a code payment terminal 3000 that may permit a user to make a payment via a code that is associated with a user's mobile device and that can be scanned by a scanner associated with the code payment terminal 3000.

The contactless payment environment may also include a workstation 550 and a processing system 600 that are in electronic communication with the payment terminal via a network 350, which may be the Internet, an intranet or the like. The LEDs 315 situated on the payment terminal that perform the functions described above are also displayed in FIG. 3.

In FIG. 3, the network 350 may include a local area network (LAN), a wide area network (WAN), and/or a global area network (GAN). The network 350 may provide for wireline, wireless, or a combination of wireline and wireless communication between devices in the network. In one embodiment, the network 350 includes the Internet. In one embodiment, the network 350 may include a wireless telephone network.

The mobile device 400 and the payment terminal 500 are described in further detail below.

### Contactless Payment System

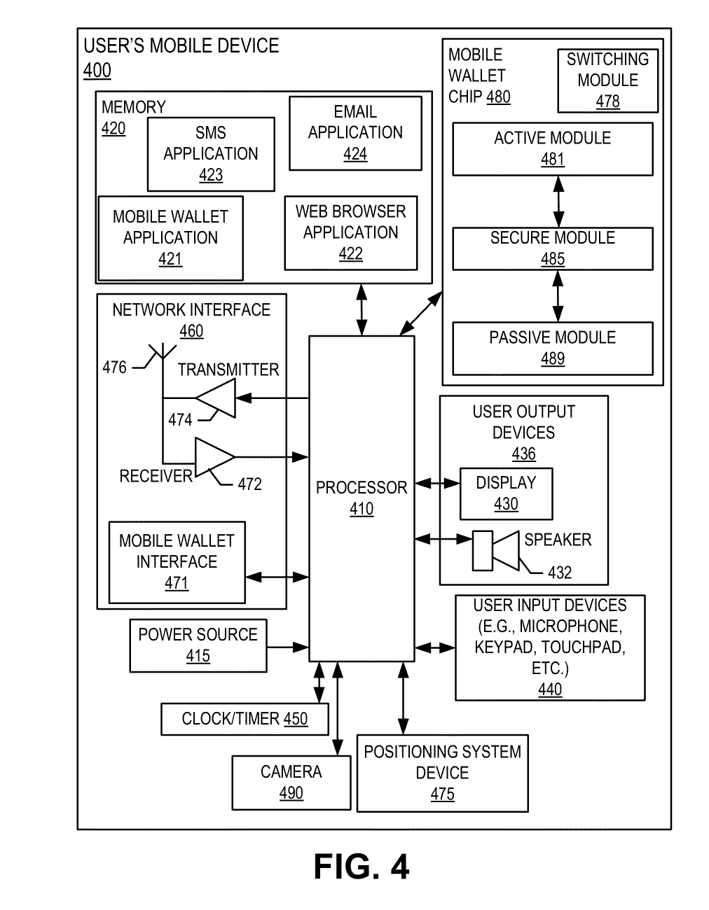

FIG. 4 displays an embodiment of a mobile device that may be configured to make a contactless payment at a payment terminal 500. As used herein, a “mobile device” 400 may be any mobile communication device, such as a cellular telecommunications device (i.e., a cell phone or mobile phone), personal digital assistant (PDA), a mobile Internet accessing device, or other mobile device.

In one embodiment of the invention, the mobile device 400 may be a mobile telephone. However, it should be understood, however, that a mobile telephone is merely illustrative of one type of mobile device 400 that may benefit from, employ, or otherwise be involved with embodiments of the present invention and, therefore, should not be taken to limit the scope of embodiments of the present invention. Other types of mobile devices 400 may include portable digital assistants (PDAs), pagers, mobile televisions, gaming devices, laptop computers, cameras, video recorders, audio/video player, radio, GPS devices, any combination of the aforementioned, or the like.

The mobile device 400 may generally include a processor 410 communicably coupled to such devices as a memory 420, user output devices 436, user input devices 440, a network interface 460, a power source 415, a clock or other timer 450, a camera 490, a positioning system device 475, a mobile wallet chip 480, etc. The processor 410, and other processors described herein, may generally include circuitry for implementing communication and/or logic functions of the mobile device 400. For example, the processor 410 may include a digital signal processor device, a microprocessor device, and various analog to digital converters, digital to analog converters, and/or other support circuits. Control and signal processing functions of the mobile device 400 may be allocated between these devices according to their respective capabilities. The processor 410 thus may also include the functionality to encode and interleave messages and data prior to modulation and transmission. The processor 410 may additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the mobile device 400 to transmit and receive web content, such as, for example, location-based content and/or other web page content, according to a Wireless Application Protocol (WAP), Hypertext Transfer Protocol (HTTP), and/or the like. The processor 410 may also be capable of operating a client application, such as a mobile wallet application that is represented by block 421.

As shown in FIG. 4, in one embodiment of the invention, the mobile wallet application 421 may be downloaded from an application server and stored in the mobile device's memory 420. In another embodiment, the mobile wallet application may be pre-installed and stored in a memory in the mobile wallet chip 480. In such an embodiment, the user may not need to download the mobile wallet application 421 from an application server. In some embodiments, the mobile wallet application 421 may have a graphical user interface (GUI) that allows the user to perform various processes as described below. The GUI may also allow the user to set certain payment preferences or mobile wallet preferences.

In one embodiment, the mobile wallet application 421 may provide the software capability for the active module 481 and the passive module 489 to enable those modules to perform the various process blocks of FIG. 1. In one embodiment, the mobile wallet application 421 may even provide the software capability for the switching module 478 to enable the switching module 478 to perform the various process blocks of FIG. 1.

In one embodiment, the mobile wallet application 421 may be capable of interacting with or enabling the active module to present to a user one or more payment vehicles that may be stored in the secure module 485. The mobile wallet application 421 may also be capable of interacting with or enabling the active module 481 to automatically select one or more payment vehicles or receive a user's selection of one or more payment vehicles. The mobile wallet application 421 may also be capable of allowing a user to input information for new payment vehicles, or downloading payment vehicle information, via a network, from a user's account associated with a payment vehicle.

In one embodiment during an active payment routine, the mobile wallet application 421 may be capable of working in conjunction with the mobile device's hardware to transmit payment vehicle data associated with a payment vehicle selected by a user to a payment terminal according to embodiments described above. In one embodiment during a passive payment routine, the mobile wallet application 421 may also be capable of working in conjunction with the mobile device's hardware to allow either an identifier associated with the passive module 489 or payment vehicle data associated with a default payment vehicle to be transmitted to a payment terminal according to embodiments described above.

The mobile wallet chip may comprise a switching module 478 that performs the various process blocks described with respect to FIG. 1. In one embodiment, the switching module 478 may be integrated into the mobile wallet chip 480. The switching module 478 may be capable of interacting with the active module 481, the secure module 485, and the passive module 489. In some embodiments, the switching module 478 may be part of the mobile device, though not integrated into the mobile wallet chip 480. In one embodiment, the switching module 478 may be integrated into the active module 481 or the passive module 489.

The mobile wallet chip 480 may comprise an active module 481, a secure module 485, and a passive module 489. In one embodiment, the mobile wallet chip 480 may be an integrated circuit, a microprocessor, a system-on-a-chip, a microcontroller, or the like. In one embodiment, the active module 481 may be an active Near Field Communication (NFC) device. The active module 481 is “active” because a power source in the mobile device supplies the power for transmitting payment vehicle data associated with a payment vehicle selected by the user. In one embodiment, the passive module 489 may be a passive NFC device. The passive module 489 is “passive” because no power source in the mobile device supplies the power for transmitting payment vehicle data associated with the default payment vehicle.

The secure module 485 may be a memory device in the mobile wallet chip 480. In one embodiment the secure module 485 may comprise payment vehicle data associated with a plurality of payment vehicles. For instance, FIG. 2 comprises data that may be stored in the secure module 485. Therefore, in one embodiment, payment vehicle data for each payment vehicle that is stored in the secure module 485 may include the payment vehicle type, the payment vehicle number, the name associated with the payment vehicle, the expiration date of the payment vehicle, the security code associated with the payment vehicle, whether the payment vehicle is a credit or debit payment vehicle, etc. Therefore, in an embodiment, the secure module 485 may comprise data indicating whether a payment vehicle is a default payment vehicle. As indicated earlier, in one embodiment, only a single payment vehicle may be selected as the default payment vehicle. Since the secure module 485 is stored in a memory in the mobile wallet chip 480 and not in a memory in the mobile device, the user may be able to transfer the mobile wallet chip 480, if the mobile wallet chip 480 is not integrated into the mobile device, to another mobile device and the user may consequently have access to the payment vehicles in the mobile wallet chip 480 on a different mobile device.

In embodiments where payment vehicle data associated with a default payment vehicle, rather than an identifier associated with the passive module 489, is transmitted to a payment terminal when the passive routine is executed, the secure module 485 may store the payment vehicle data in the form of a look-up table as displayed in FIG. 2. In such an embodiment, the secure module 485 may allow a user to change the payment vehicle that serves as the default payment vehicle by allowing the user to access the look-up table via a mobile wallet application 421 when a power source in the mobile device that supplies power to a processor that executes the mobile wallet application 421 is present and active. In one embodiment, the power source that supplies power to the active module 481, as described below, may be the same power source that supplies power to a processor that executes the mobile wallet application 421.

In embodiments where an identifier associated with the passive module 489, rather than payment vehicle data associated with a default payment vehicle, is transmitted when the passive routine executed, a remote server may store the payment vehicle data in the form of a look-up table as displayed in FIG. 2. As explained in an earlier section, in some embodiments, a user may change the payment vehicle that serves as the default payment vehicle by accessing the look-up table, via a network such as the Internet, on a computing platform such as a personal computing device, a mobile computing device, or the like.

The active module 481 may enable a user to make a contactless payment at a payment terminal when a power source in a mobile device is present and active. A power source in a mobile device may be present when the power source is properly slotted into the mobile device. A power source in a mobile device may be active when the power source is able to supply power to the active module 481. The power source that supplies power to the active module 481 may also supply power to other components of the mobile device. In one embodiment, the power source that supplies power to the active module 481 may be the only power source in the mobile device.

When the power source that supplies power to the active module 481 in a mobile device is both present and active, the user may select a payment vehicle via the mobile wallet application 421 described above. Subsequently, the mobile device may transmit to a payment terminal, payment vehicle data associated with the selected payment vehicle that is stored in the mobile device, or, more specifically, in the secure module 485 of the mobile wallet chip 480, wherein the power for making this transmission is supplied by a power source in the mobile device. The power source that supplies power for making this transmission may either be the same power source or a different power source from the power source that supplies power to the active module 481 in a mobile device.

The passive module 489 may enable a user to make a contactless payment at a payment terminal when the power source that supplies power to the active module 481 in a mobile device is either not present or not active. A power source in a mobile device may not be present when it is either missing from the mobile device or improperly slotted into the mobile device. In one embodiment, a power source that supplies power to the active module 481 in a mobile device may not be active when the power source is unable to supply power to the active module 481. In one embodiment, a power source that supplies power to the active module 481 in a mobile device may not be active when the power source is unable to supply power to the active module 481, regardless of whether it is able to supply power to other components of the mobile device. In one embodiment, a power source that supplies power to the active module 481 may not be active when it is unable to supply power to the active module 481, regardless of whether other power sources in the mobile device are able to supply power to other components or modules of the mobile device. The power source that supplies power to the active module 481 may be unable to supply power when the power source is faulty, when the power source is discharged, when the mobile device is turned “off,” when the mobile device is dead, or the like. In one embodiment, the passive module 489 may be deactivated when the power source that supplies power to the active module 481 is both present and active. This may prevent payment vehicle data associated with the default payment vehicle or an identifier associated with the passive module 489 to be accidentally transmitted from the mobile device to an apparatus such as a payment terminal. In such an embodiment, even though the passive module 489 may be deactivated, a user may still be able to access a look-up table to change the payment vehicle that serves as the default payment vehicle, as described in earlier embodiments.

When the power source that supplies power to the active module 481 in a mobile device is either not present or not active, the passive module 489 of the mobile device may allow a contactless payment via a default payment vehicle that is stored in the mobile device, or, more specifically, in the secure module 485 of the mobile wallet chip 480. In one embodiment, the passive module 489 may allow a user to make a contactless payment when all power sources in a mobile device that supply power to the active module 481 in the mobile device are either not present or not active.

In order to make a payment during the passive payment routine, the mobile device may transmit payment vehicle data associated with the default payment vehicle, or an identifier associated with the passive module 489 as described above, from the mobile device to a payment terminal, wherein the power for making this transmission may be supplied by an external source, such as the payment terminal or the like. In one embodiment, an electromagnetic field of the payment terminal may supply the power for making the transmission. Therefore, in one embodiment, there is no power source in the mobile device that may supply power to the passive module 489 for making the transmission.

However, in another embodiment, a solar or photovoltaic power source in the mobile device may be activated when a power source that supplies power to the active module 481 is either not present or not active. In one embodiment, the solar power source may be a solar cell, a photovoltaic cell, or the like. This solar power source may have been charged by sunlight when the mobile device was previously exposed to sunlight or some other form of radiation depending on the type of photovoltaic power source. The solar power source may supply power to the passive module 489 that may allow the mobile device to make a contactless payment via a default payment vehicle that is stored in the mobile device, or in the secure module 485 of the mobile wallet chip 480, or via an identifier associated with the passive module 489. In some embodiments, the solar power source may also supply power to other components of the mobile device, but the solar power source may not supply power to the active module 481 of the mobile wallet chip 480. Therefore, in an embodiment where a solar power source supplies power to the passive module 489, the electromagnetic field of the payment terminal may not supply power to the passive module for transmitting payment vehicle data associated with the default payment vehicle during the passive payment routine.

The processor 410 may be configured to use the network interface 460 to communicate with one or more other devices on the network 350. In this regard, the network interface 460 may include an antenna 476 operatively coupled to a transmitter 474 and a receiver 472 (together a “transceiver”). The processor 410 may be configured to provide signals to and receive signals from the transmitter 474 and receiver 472, respectively. These signals may include radio frequency signals emanating from the mobile device's transmitter 474 when the mobile device is tapped at or held or waved in close proximity to the payment terminal. These signals may also include radio frequency signals received at the mobile device's receiver 472 when the mobile device is tapped at or held or waved in close proximity to the payment terminal. In one embodiment, these radio frequency signals may be transmitted and received in the radio frequency band of 13.56 MHz. In one embodiment, the ISO/IEC 14443 standard may define the protocol associated with the data carried by these radio frequency signals. In one embodiment, the transmitter 474 and receiver 472 at the mobile device may transmit and receive radio frequency signals, respectively, from a payment terminal within a distance of up to 25 cm.

As indicated earlier, the processor 410 may be configured to provide signals to and receive signals from the transmitter 474 and receiver 472, respectively. The signals may also include signaling information in accordance with the air interface standard of the applicable cellular system of the wireless telephone network that may be part of the network 350. In this regard, the mobile device 400 may be configured to operate with one or more air interface standards, communication protocols, modulation types, and access types. By way of illustration, the mobile device 400 may be configured to operate in accordance with any of a number of first, second, third, and/or fourth-generation communication protocols and/or the like. For example, the mobile device 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 400 may also be configured to operate in accordance with non-cellular communication mechanisms, such as via a wireless local area network (WLAN) or other communication/data networks.

The network interface 460 may also include a mobile wallet interface 471 in order to allow a user to execute some or all of the above-described processes with respect to the mobile wallet application 421 and the active 481 and passive 489 modules of the mobile wallet chip 480. The mobile wallet interface 471 may have access to the hardware, e.g., the transceiver, and software previously described with respect to the network interface 460.

In one embodiment, the mobile device may comprise a first transceiver that works in conjunction with the active module 481 of the mobile device and a second transceiver that works in conjunction with the passive module 489. Therefore, the antenna and other hardware or software that transmit payment vehicle data from the active module 481 of the mobile device may be separate from the antenna and other hardware or software that allows payment vehicle data from the passive module 489 of the mobile device to be transmitted to a payment terminal. In one embodiment, the transceiver and other hardware for transmitting payment vehicle data from the active module 481 may be integrated into the active module 481. In one embodiment, the transceiver and other hardware that allows payment vehicle data from the passive module 489 of the mobile device to be transmitted may be integrated into the passive module 489.

As described above, the mobile device 400 may have a user interface that includes user output devices 436 and/or user input devices 440. The user output devices 436 may include a display 430 (e.g., a liquid crystal display (LCD) or the like) and a speaker 432 or other audio device, which are operatively coupled to the processor 410. The user input devices 440, which may allow the mobile device 400 to receive data from a user such as the user 110, may include any of a number of devices allowing the mobile device 400 to receive data from a user, such as a keypad, keyboard, touch-screen, touchpad, microphone, mouse, joystick, other pointer device, button, soft key, and/or other input device(s).

The mobile device 400 may further include a power source 415. In one embodiment, a power source 415 is a device that supplies electrical energy to an electrical load. In one embodiment, a power source 415 may convert a form of energy such as solar energy, chemical energy, mechanical energy, etc. to electrical energy. In one embodiment, a power source 415 in a mobile device may be a battery, such as a lithium battery, a nickel-metal hydride battery, or the like, that is used for powering various circuits, e.g., the transceiver circuit, and other devices that are used to operate the mobile device 400. In some embodiments, the power source 415 may also supply power to the active module 481 of the mobile wallet chip 480. In some embodiments, the power source 415 may be a power adapter that can connect a power supply from a power outlet to the mobile device 400. In some embodiments, a power adapter may be classified as a power source “in” the mobile device.

As described previously, in some embodiments, the mobile device 400 may include a solar power source, such as a solar cell, a photovoltaic cell, or the like, that may be used to supply power to the passive module 489 of the mobile wallet chip 480 in order for the passive module 489 to execute the passive payment routine.

Embodiments of the mobile device 400 may also include a clock or other timer 450 configured to determine and, in some cases, communicate actual or relative time to the processor 410 or one or more other devices.

The mobile device 400 may also include a memory 420 operatively coupled to the processor 410. As used herein, memory may include any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory may additionally or alternatively include an electrically erasable programmable read-only memory (EEPROM), flash memory or the like.

The memory 420 may store any of a number of applications which comprise computer-executable instructions/code executed by the processor 410 to implement the functions of the mobile device 400 described herein. For example, the memory 420 may include such applications as a web browser application 422 and a mobile wallet application 421. The mobile wallet application 421 may be capable of performing one or more functions described above. These applications may also typically provide a graphical user interface (GUI) on the display 430. For instance, as described previously, the GUI for the mobile wallet application 421 may allow the user 110 to enter input to select a payment vehicle to transmit to a payment terminal. In some embodiments, the GUI for the mobile wallet application 421 may also allow the user 110 to change the payment vehicle that serves as the default payment vehicle associated with the passive module 489. Alternatively, the GUI for the web browser application 422 may also allow the user 110 to change the default payment vehicle associated with the passive module 489 by allowing the user to access a look-up table from a remote server, as discussed previously with respect to an embodiment of the invention.

The memory 420 may also store any of a number of pieces of information, and data, used by the mobile device 400 and the applications and devices that make up the mobile device 400 or are in communication with the mobile device 400 to implement the functions of the mobile device 400 and/or the other systems described herein. For example, the memory 420 may include such data as user authentication information to gain access to the mobile wallet application 421, user authentication information for each payment vehicle that is stored by or accessible via the mobile wallet application 421, user authentication information to access the secure module 485 of the mobile wallet chip 480, etc. In other embodiments, this authentication information may be stored in a memory of the mobile wallet chip 480.

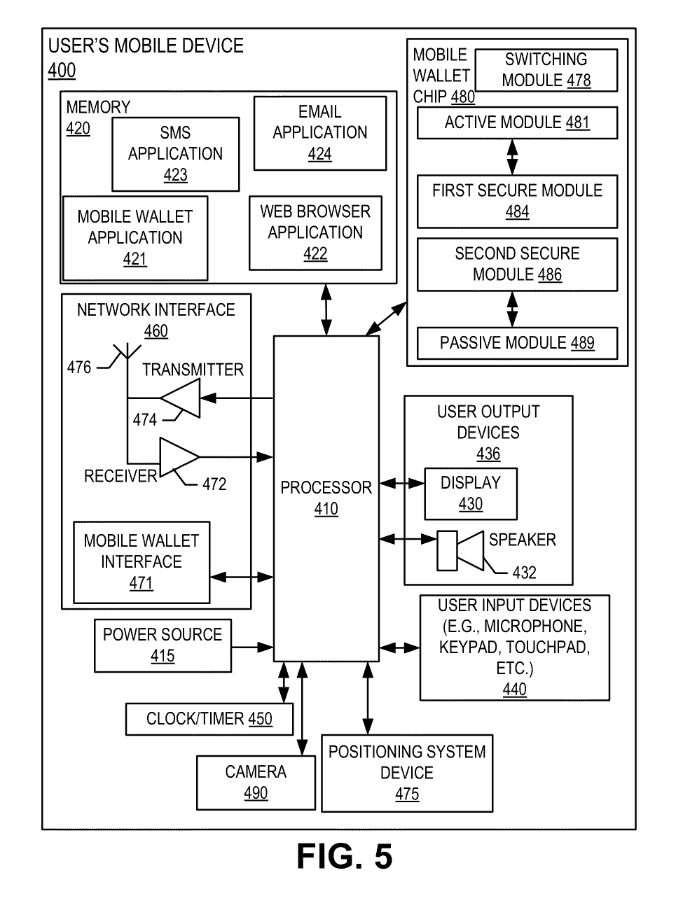

FIG. 5 displays an illustration of an alternate embodiment of a mobile device 400 where the mobile wallet chip 480 may comprise an active module 481, a first secure module 484, a second secure module 486, and a passive module 489. Both the active 481 and passive 489 modules have been described in previous embodiments. The mobile wallet chip may also comprise a switching module 478 that has been described previously.

The first secure module 484 may comprise payment vehicle data associated with a plurality of payment vehicles. These payment vehicles may be the plurality of payment vehicles presented to the user by the active module 481 when the active module 481 executes the active payment routine as described earlier. In one embodiment, the first secure module 484 may not comprise data indicating whether any of the payment vehicles is the default payment vehicle. The active module 481 may access payment vehicle data associated with a plurality of payment vehicles stored in the first secure module 484 when the active module 481 executes the active payment routine.

In the embodiment displayed in FIG. 5, the passive module 489 may interact with the second secure module 486 that is stored in a memory in the mobile wallet chip 480. The second secure module 486 may comprise payment vehicle data for a default payment vehicle. In one embodiment, the default payment vehicle may be one of the payment vehicles that is stored in the first secure module 484; however, the first secure module 484 may not comprise data indicating that this payment vehicle is the default payment vehicle. The passive module 489 may access payment vehicle data associated with a default payment vehicle stored in the second secure module 486 when the passive module 489 executes the passive payment routine.

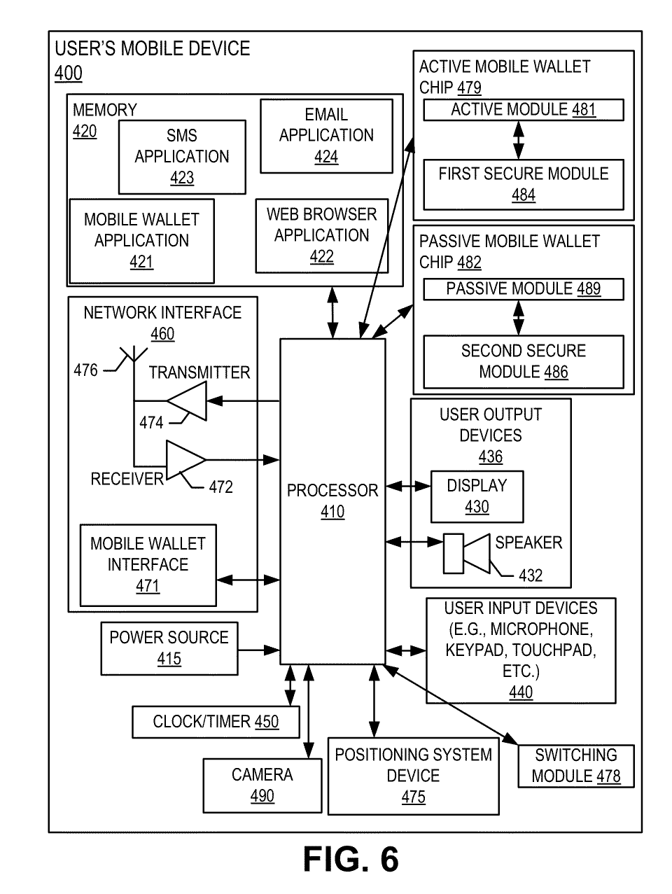

FIG. 6 displays an illustration of a further alternate embodiment of a mobile device 400 that comprises an active mobile wallet chip 479 and a passive mobile wallet chip 482. The active mobile wallet chip 479 may comprise an active module 481 and a first secure module 484, both which have been described in previous embodiments. The passive mobile wallet chip 482 may comprise a passive module 489 and a second secure module 486, both which have been described in previous embodiments.

In FIG. 6, the switching module 478 is depicted as being present outside either mobile wallet chip. However, in other embodiments, the switching module 478 may be located in the passive mobile wallet chip 482, wherein the switching module in the passive mobile wallet chip may turn “on” the passive module 489 when one or more switching conditions are detected by the switching module 478. In one embodiment, there may be a switching module located in the active mobile wallet chip 479 and a separate switching module located in the passive mobile wallet chip 482. In some embodiments, as described previously, the active module 481 may need to be turned “off” by a switching module, and in such embodiments, the switching module in the active mobile wallet chip 479 may be able to turn “off” the active module 481, while the switching module in the passive mobile wallet chip 482 may be able to turn “on” the passive module 489. In some embodiments, one or more switching modules may be located in the mobile device, either inside or outside one or more mobile wallet chips, and these one or more switching modules may be able to turn “on” and turn “off” one or more active modules or one or more passive modules in the mobile device.

### Other Devices/Systems in the Contactless Payment Environment

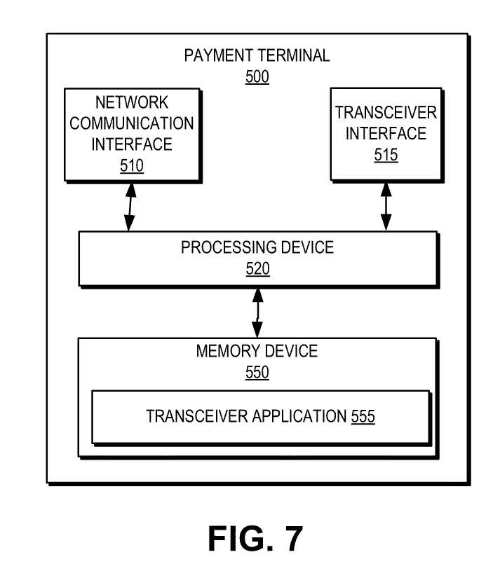

FIG. 7 displays an embodiment of a payment terminal 500 that is displayed in FIG. 3. The payment terminal 500 may include various features, such as a network communication interface 510, a processing device 520, a transceiver interface 515, and a memory device 550 that may include a transceiver application 555. The payment terminal display in FIG. 7 may be a contactless payment terminal or a contact payment terminal. In a contactless payment environment, the user may make a payment without touching or tapping the mobile device to the contactless payment terminal. In a contact payment environment, the user may make a payment by touching or tapping the mobile device (or some other module that is either coupled to the mobile device or is removable from the mobile device) at the contact payment terminal.

As used with respect to the payment terminal 500, a “communication interface” may generally include a modem, server, transceiver, and/or other device for communicating with other devices on a network. The network communication interface may be a communication interface having one or more communication devices configured to communicate with one or more other devices in the contactless payment environment 300, such as the mobile device 400, the workstation 550, the processing system 600, other processing systems, data systems, etc.

In one embodiment, the transceiver interface 515 is a separate module that may generally include a transceiver, i.e., one or more antennas and/or other electronic circuitry, devices, and software, for receiving electronic payment vehicle data when the mobile device is held close to or tapped at the payment terminal. Data received by the processing device 520 may be used to execute the various process blocks of the payment terminal, as described above with respect to FIG. 1. In other embodiments, the transceiver interface 515 is part of the network communication interface 510. In some embodiments, the transceiver interface 515 may also be used as an interface to send data to the mobile device 400 when the mobile device 400 is held close to or tapped at the payment terminal. In some embodiments, the transceiver interface 515 may provide an electromagnetic field that may supply power to the passive module 489 of a user's mobile device.

An output device for the transceiver interface 515 may include a display that provides instructions regarding the steps for making a contactless payment or for making a contact payment. In some embodiments where the payment terminal requests the user's signature, the display may also serve as a touchpad input device to input the user's signature via a stylus. Other output devices may include one or more LEDs or an audio speaker, both which may indicate to the user that data has been successfully received from the mobile device 400. A printer that can print paper receipts may also be incorporated into the payment terminal. Other embodiments of the payment terminal may carry other input and output devices, such as a mouse, keyboard, button, touchpad, touch screen, microphone, speaker, light, joystick, switch, or the like.

As used with respect to the payment terminal 500, a “processing device,” such as the processing device 520, may generally refer to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system may be allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 520 may be configured to use the network communication interface 510 and/or the transceiver interface 515 to transmit and/or receive data and/or commands to and/or from the other devices that are visible in the contactless payment environment 300.

As used with respect to the payment terminal 500, a “memory device” may generally refer to a device or combination of devices that store one or more forms of computer-readable media for storing data and/or computer-executable program code/instructions. For example, in one embodiment, the memory device may include any computer memory that provides an actual or virtual space to temporarily or permanently store data and/or commands provided to the processing device when it carries out its functions described herein. In one embodiment, the memory device stores a transceiver application 555. The transceiver application 555 may work in conjunction with the previously described transceiver interface 515 to receive electronic payment vehicle data when the mobile device is held close to or tapped at the payment terminal. In some embodiments, the transceiver application 555 may also be configured to send data to the mobile device when the mobile device is held close to or tapped at the payment terminal.

As shown in FIG. 3, in some embodiments, a payment terminal is connected to a workstation 550 via the network 150. The workstation 550 may be used by the cashier or other personnel to interact with the payment terminal. The workstation 550 may include various features, such as a network communication interface, a processing device, a user interface, and a memory device.

As used with respect to the workstation 550, a “communication interface” may generally include a modem, server, transceiver, and/or other device for communicating with other devices on a network. The network communication interface may be a communication interface having one or more communication devices configured to communicate with one or more other devices on the network 350, such as the payment terminal, the processing system, other processing systems, data systems, etc.

As used with respect to the workstation 550, a “processing device” may generally refer to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system may be allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device may be configured to use the network communication interface to transmit and/or receive data and/or commands to and/or from the other devices connected to the network 350.

As used with respect to the workstation 550, a “user interface” may generally include a plurality of interface devices and/or software that allow a user to input commands and data to direct the processing device to execute instructions. For example, the user interface may include a graphical user interface (GUI) or an interface to input computer-executable instructions that direct the processing device to carry out specific functions. The user interface may employ certain input and output devices to input data received from the user or the cashier or output data to the user or the cashier. These input and output devices may include a display, mouse, keyboard, button, touchpad, touch screen, microphone, speaker, light, joystick, switch, and/or other customer input/output device for communicating with one or more customers. As used with respect to the workstation 550, a “memory device” may generally refer to a device or combination of devices that store one or more forms of computer-readable media for storing data and/or computer-executable program code/instructions. For example, in one embodiment, the memory device may include any computer memory that provides an actual or virtual space to temporarily or permanently store data and/or commands provided to the processing device when it carries out its functions described herein.

### Back-Up Payment System

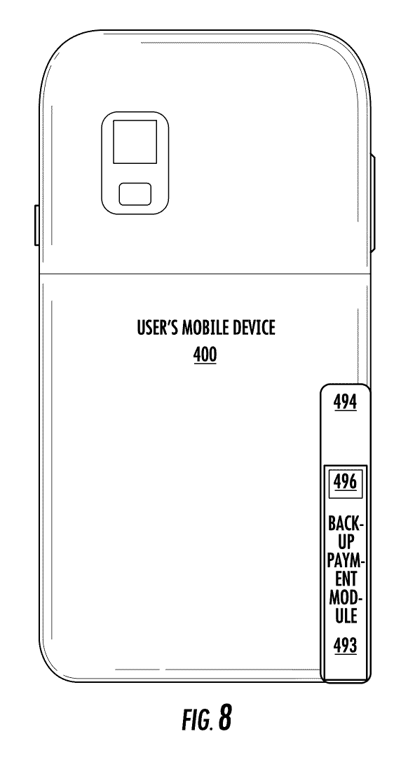

FIG. 8 displays an embodiment of a mobile device that may be configured to make a payment at a contact payment terminal 510 by establishing physical contact between the back-up payment module 493 and the contact payment terminal. Therefore, the back-up payment module may sometimes be referred to as a contact payment module. The back-up payment module is similar to the passive module 489, and can be used to make a payment at a contact payment terminal. In one embodiment, the back-up payment module comprises a magnetic stripe that comprises payment information for one or more payment vehicles. When a back-up payment module comprises a magnetic stripe, the back-up payment module may also be referred to as a contact payment module. This magnetic stripe may be swiped through (or otherwise make contact with) a contact payment terminal that has the capability to read magnetic stripe payment information. In accordance with embodiments of the invention, the act of swiping a back-up payment module through a contact payment terminal may also refer to an act of touching the contact payment terminal with a back-up payment module such that a payment is made by this act. The back-up payment module may be housed in a housing 494 that is situated inside the mobile device. In one embodiment, the dimensions of the housing may be similar to the dimensions of the back-up payment module. In another embodiment, the dimensions of the housing may be greater than the dimensions of the back-up payment module (see FIG. 8). In some embodiments, the dimensions of the housing may be smaller than (or even dissimilar when compared to) the dimensions of the back-up payment module. In such embodiments, the back-up payment module has to fold into two or more parts so that the parts of the payment module can be stacked and fit into the housing. In embodiments where the back-up payment module comprises a magnetic stripe, the housing allows the back-up payment module to retain its properties (e.g., magnetic properties) that allow it to store payment vehicle information and allow a user to make a payment at a contact payment terminal using the back-up payment module. Therefore, the housing may be made with material that protects the back-up payment module from forces that disturb the magnetic state or orientation of the back-up payment module.

In one embodiment, the back-up payment module may only be used when a power source in the device is neither present nor active. As previously described, a power source in a mobile device may not be present when it is either missing or improperly slotted into the mobile device. In one embodiment, a power source in a mobile device may not be active when it is unable to supply power to the active module. In one embodiment, a power source in a mobile device may not be active when it is unable to supply power to the active module, regardless of whether it is able to supply power to other components of the mobile device. The power source may be unable to supply power when the power source is faulty, when the power source is discharged, when the mobile device is turned “off,” when the mobile device is dead, or the like.

However, in other embodiments, the back-up payment module may be used even when a power source in the device is present and active. For instance, a store may not have a contactless payment terminal; therefore, in such an instance, a user who uses a mobile device as a primary payment vehicle can still use the mobile device to make a payment without having to carry a credit card, a debit card or the like.

In some embodiments, the back-up payment module functions independently of the rest of the mobile device. Therefore, in some embodiments, the back-up payment module is always active and can be used regardless of whether there is power or no power in the mobile device. However, in some embodiments, when a power source is either not present or not active, the back-up payment module is activated (in addition to the passive module described above). This gives the user an option to make either a contact payment or a contactless payment when a power source in a mobile is either not present or not active. The various switching mechanisms described above that turn ‘on’ and turn ‘off’ the passive module are applicable to the back-up payment module as well.

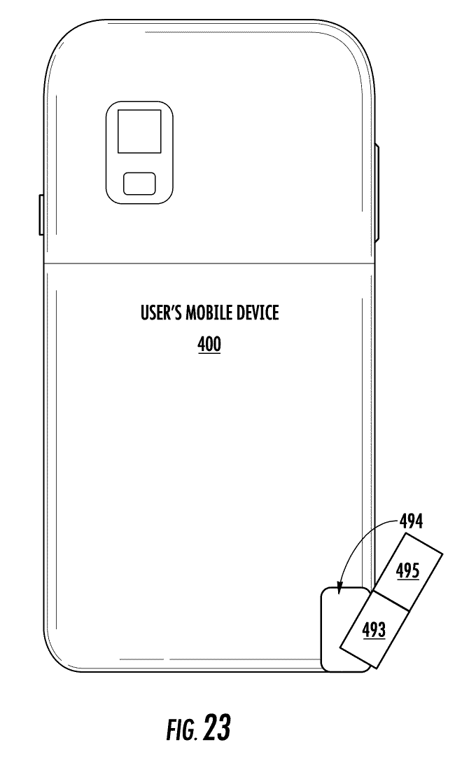

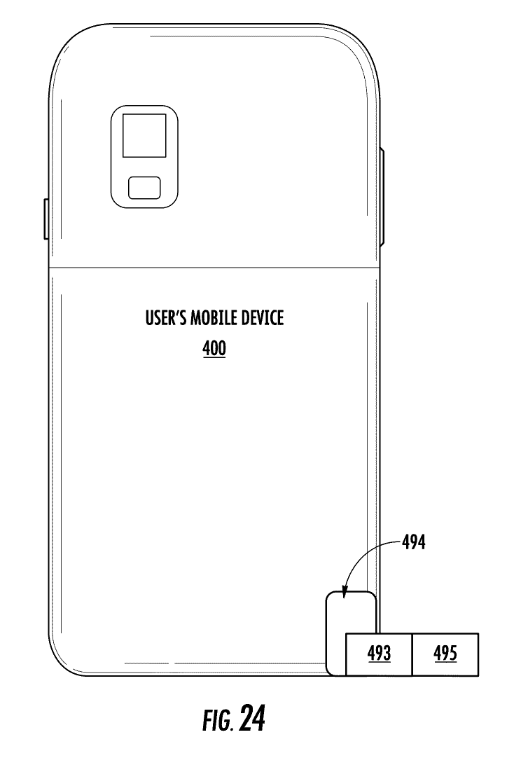

As shown in FIGS. 8-28, the processor 410 may interact with the back-up payment module. In some embodiments, the processor may be involved in switching ‘on’ and switching ‘off’ the back-up payment module. However, in other embodiments, the processor may be involved in adding, changing, or deleting payment vehicle information stored in the back-up payment module. The process of executing these tasks has been previously explained with respect to the passive module. A similar process of executing these tasks will be explained later with respect to the back-up payment module.

In some embodiments, there may be more than one back-up payment module in a mobile device. In an embodiment where each back-up payment module has the capability to carry payment vehicle information for only one payment vehicle, each back-up payment module carries payment vehicle information for a separate payment vehicle. This is similar to a user carrying more than one payment card such as a debit card issued by a first financial institution, a credit card issued by a second financial institution, a gift card issued from retailer, and the like in a physical wallet. In some embodiments, each back-up payment module may be based on a different technology, so that a user has several back-up payment modules, a user makes a purchase at a retailer that does not offer a particular mode of payment. For instance, one payment module may be based on magnetic stripe technology, while another payment module may be based on code (e.g., barcode) technology (described below). In an embodiment where the back-up payment module comprises a magnetic stripe, the magnetic stripe stores magnetically readable data. The magnetic stripe may be positioned on either the top or bottom surface of the back-up payment module. The magnetic stripe may be positioned along the longer or shorter edge of the back-up payment module. In one embodiment, a back-up payment module may comprise more than one distinct magnetic stripe along one or more edges of the back-up payment module. Each distinct magnetic stripe may comprise magnetically readable data for one or more payment vehicles.

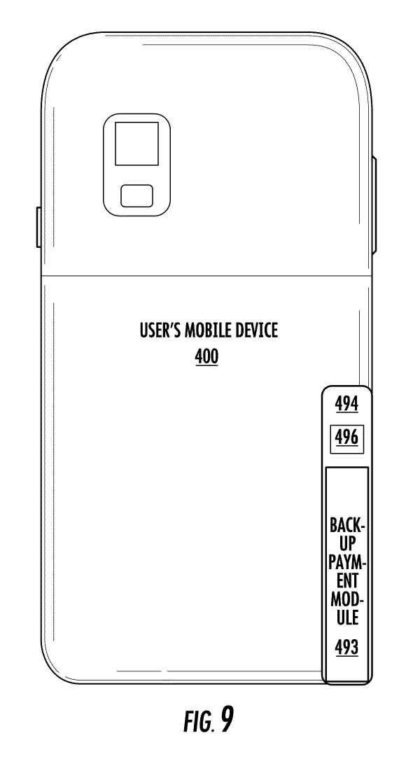

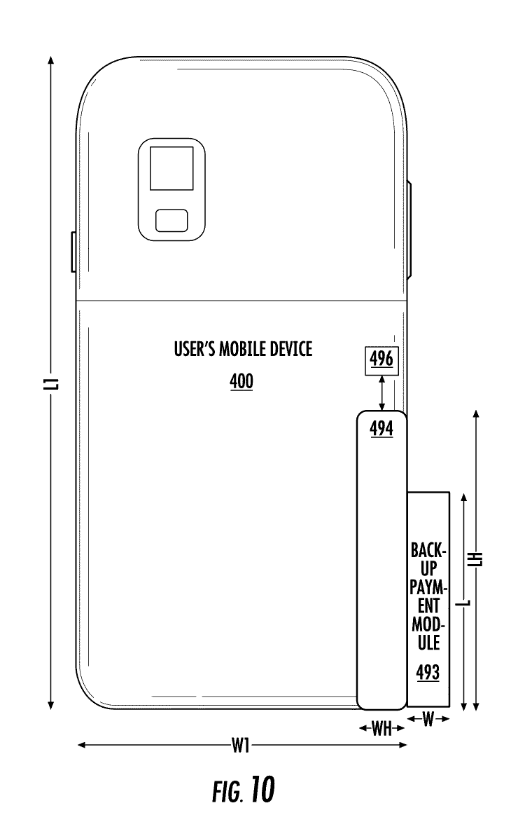

In one embodiment, the magnetically readable data stored in the back-up payment module may be altered, i.e., the magnetic stripe is a dynamic magnetic stripe. For instance, the back-up payment module may comprise a converter module 496 (see FIG. 8). In an embodiment where the dynamic magnetic stripe comprises a single payment vehicle, the converter module has the ability to replace this payment vehicle with another payment vehicle or erase this payment vehicle altogether. In an embodiment where the dynamic magnetic stripe comprises more than one payment vehicle, the converter module may add a new payment vehicle onto the dynamic magnetic stripe, change the data associated with a single payment vehicle on the dynamic magnetic stripe, erase a particular payment vehicle on the dynamic magnetic stripe, set a new default payment vehicle on the dynamic magnetic stripe, etc. In order to accomplish each of these actions, a mobile device may comprise an application that works in conjunction with the converter module to allows a user to add a new payment vehicle, change the data associated with a single payment vehicle, erase a particular payment vehicle, set a new default payment vehicle, etc. When a user chooses an action that the user wishes to execute, the action is executed by the converter module. For instance, a user may choose a new payment module that the user wishes to add onto the back-up payment module via an application (e.g., a GUI application) on the mobile device. When the user confirms his or her choice of a new payment module, the converter module in the back-up payment module causes a state change of the magnetic data comprised within the magnetic stripe. The converter module comprises a read/write mechanism in order to cause this state change. In some embodiments, the converter module may be located outside the back-up payment module but within the housing 494 (see FIG. 9). In other embodiments, the converter module may be located outside the housing but within the mobile device (see FIG. 10).

Alternatively, in some embodiments, a user may be able to choose one or more of the above mentioned actions on a separate computing device, e.g., adding a new payment vehicle to the back-up payment module, changing the data associated with a single payment vehicle that is currently stored in the back-up payment module, erasing a particular payment vehicle that is currently stored in the back-up payment module, setting a new default payment vehicle among the payment vehicles stored in the back-up payment module, etc. Therefore, for instance when the user confirms his or her choice of a new payment vehicle, this information is transmitted to a server. Subsequently, the server communicates the action to a communication device that wirelessly communicates this action, via a communication mechanism, to the user's mobile device. Subsequently, the converter module 496 in the back-up payment module causes a state change of the magnetic data comprised within the magnetic stripe of the back-up payment module.

As described above, in some embodiments, the converter module is located in the mobile device. Also as described above, in other embodiments, the converter module is located in the mobile device, but outside the back-up payment module. In some embodiments where the converter module is located in the mobile device, the converter module may be removable/detachable from and insertable into the mobile device by a user. In some embodiments, the converter module may be an external device such as the ‘Back-up payment module Change Terminal’ 516 in FIG. 3. When a user swipes the dynamic magnetic stripe of the back-up payment module through the change terminal, the change terminal has the ability to cause a state change of the magnetically readable data stored in the dynamic stripe. Therefore, in an embodiment where the dynamic magnetic stripe comprises a single payment vehicle, the change terminal can replace this payment vehicle with another payment vehicle or erase the currently stored payment vehicle altogether. In an embodiment where the dynamic magnetic stripe comprises more than one payment vehicle, the change terminal can add a new payment vehicle, change the data associated with a single payment vehicle, erase a particular payment vehicle, set a new default payment vehicle, etc. The change terminal may be connected, either directly or indirectly, to a computing device. This computing device may have access to an application that allows a user to input instructions to add a new payment vehicle, change the data associated with a single payment vehicle, erase a particular payment vehicle, set a new default payment vehicle, etc. When a user chooses an action that the user wishes to execute via an input means to the computing device, the action is executed when the dynamic magnetic stripe is swiped through the change terminal.

In one embodiment, the converter module may be powered by an internal power source located in the mobile device. Examples of internal power sources in the mobile device have been previously described. For instance, an internal power source may include a battery, a solar cell, or electric power received from a wall outlet, etc. In other embodiments, the converter module may be powered by an external power source located outside the mobile device. For instance, in some embodiments, the mobile device may be introduced into the electromagnetic field of an external device (such as a contactless payment terminal 500), and the converter module may be able to wirelessly derive power from this external electromagnetic field in order to effect a state change of the magnetically readable data stored in the magnetic stripe of the back-up payment module.

The back-up payment module may be made with be made with the same material that a payment card, such as a credit or debit card, is made with (e.g., plastic). However, in other embodiments, the plastic used in making the back-up payment module (which carries the magnetic stripe in one embodiment) may be sturdier than that used in manufacturing a payment card. Alternatively, a metal, compound, or alloy may also be used instead of plastic. In some embodiments, the back-up payment module may even be flexible or bendable. The material chosen to make the back-up payment module needs to have the ability to carry one or more magnetic stripes without one magnetic stripe affecting the magnetically readable data of another magnetic stripe. Furthermore, in some embodiments, the material chosen to make the back-up payment module may also need to be able to protect the magnetic stripes from external forces that may disrupt the magnetic states of each magnetic stripe comprised within the back-up payment module.

Although the technologies described above for the back-up payment module include magnetic stripe technology, it must be remembered that any other technologies could be incorporated into the back-up payment module as well. Therefore, the back-up payment module is not limited to the technologies described herein.

### Configurations of the Back-Up Payment Module

The dimensions (and scale) of the back-up payment module 493, housing 494, and converter module 496 presented in FIGS. 8-28 may not be accurate, and are presented merely as examples.

FIG. 8 presents an embodiment that includes several methods of making a payment via a mobile device. As shown in FIG. 8, a user may make a contactless payment via an active module 481 or a passive module 489. These methods of making a payment have been discussed previously. Alternatively, a user may make a contact payment via a back-up payment module 493 that is based on magnetic stripe technology. In some embodiments, the mobile device may comprise one or more back-up payment modules which are based on similar or different technology. For instance, a further back-up payment module may be based on code (e.g., barcode) technology (discussed below).

FIG. 9 displays an embodiment of the mobile device where the back-up payment module is the only payment module in the mobile device. In this embodiment, a mobile device may only be used to make a contact payment at a contact payment terminal, similar to how payment cards, such as credit or debit cards are swiped through (or otherwise makes contact with) contact payment terminals. As used herein, a contact payment is a payment made by physical contact between the back-up payment module and a contact payment terminal. In one embodiment, the user may swipe the back-up payment module on his or her mobile device through a contact payment terminal, or otherwise establish physical contact between the back-up payment module and the contact payment terminal. Alternatively, the user may hand over his or her mobile device to a cashier who may subsequently swipe the back-up payment module on the user's mobile device through a contact payment terminal, or otherwise establish contact between the back-up payment module on the user's mobile device and the contact payment terminal. Alternatively, if the back-up payment module is detachable, a user may be able to detach the back-up payment module from the mobile device and subsequently swipe it through (or otherwise make contact with) a contact payment terminal.

FIG. 10 displays an embodiment of the mobile device where the back-up payment module is hinged to the mobile device along the longer edge of the back-up payment module. As used herein, the term “hinged” refers to the back-up payment module being connected or attached to the mobile device or to the housing 494 via a connection, e.g., a mechanical connection such as a screw, a fastener, a snap, a barrel, or a seam, or a magnetic-based connection, or an electrical connection, etc. As used herein, when a back-up payment module is referred to as being hinged to the mobile device, it may also refer to embodiments where the back-up payment module is detachably hinged to the mobile device. As used herein, “detachable” means that the back-up payment module may be connected or disconnected by a user or the back-up payment module may be connected or disconnected automatically by the mobile device. In some embodiments, the back-up payment module is hinged to the housing 494, and not the mobile device. As used herein, whenever the back-up payment module is referred to as being hinged to the mobile device, it also means that the backup payment module may be hinged to the housing in the mobile device, rather than being directly hinged to the mobile device.

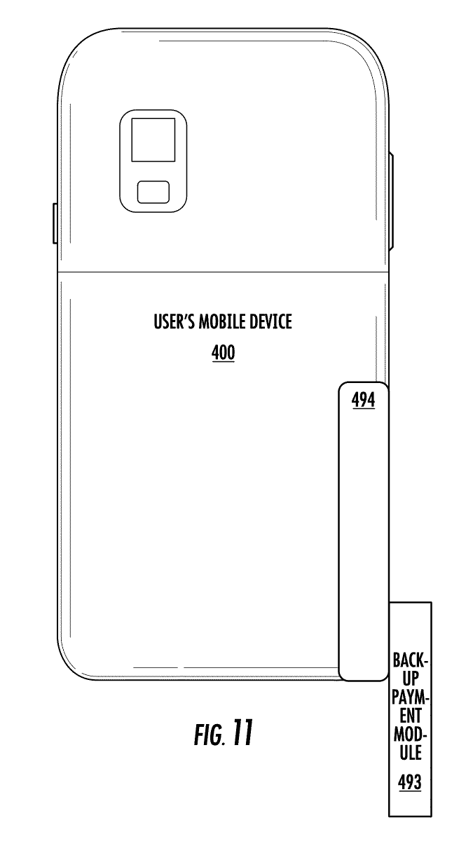

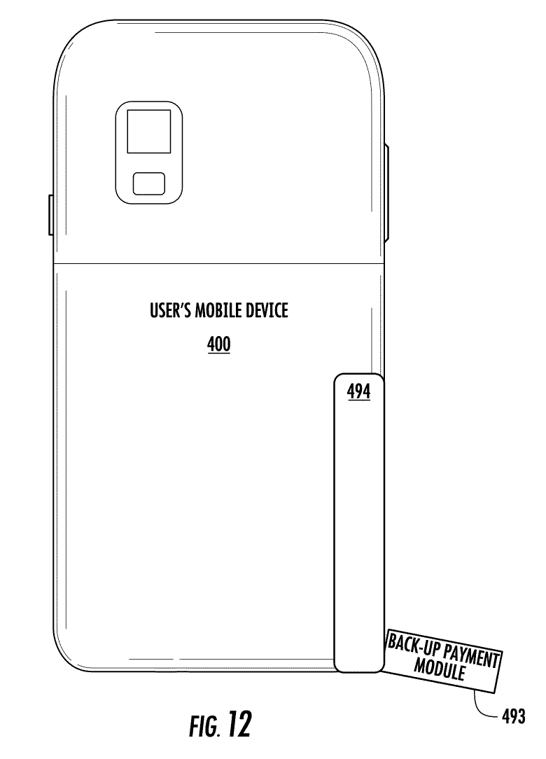

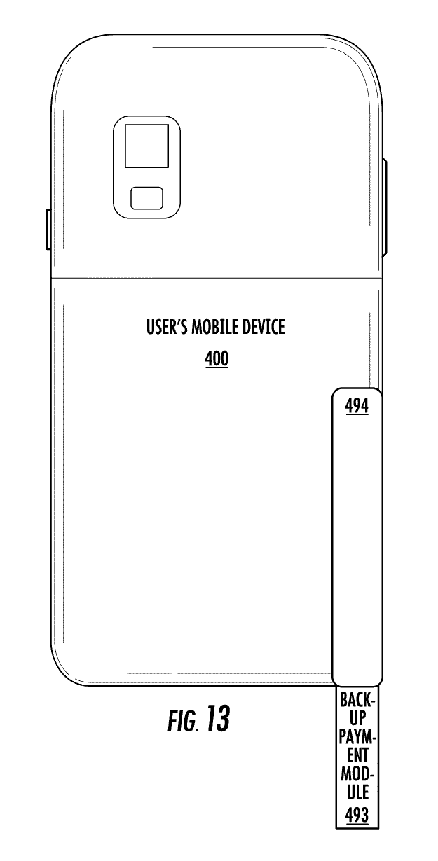

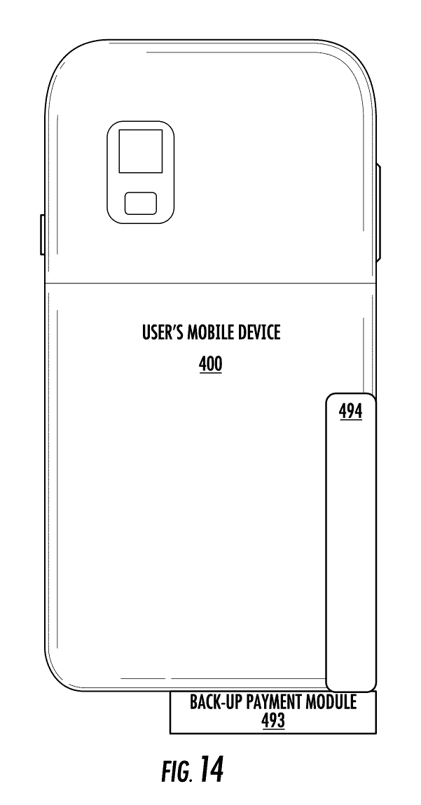

In some embodiments, the entire length L of the back-up payment module is hinged to the housing. In other embodiments, only a portion of the length L of the back-up payment module, such as the top portion, is hinged to the housing. In another embodiment, the back-up payment module may be hinged to the mobile device along the width W of the back-up payment module (FIGS. 12 and 13). Depending on the configuration of the payment terminal, the back-up payment module may be configured or oriented (i.e., rotated about the hinge (or pivot) wherein the degree of rotation is limited by the hinge (or pivot), or moved along an axis permitted by the hinge (or pivot)) accordingly in order to allow a user to swipe the back-up payment module through the contact payment terminal, or otherwise enable a user to facilitate contact between the back-up payment module and the contact payment terminal such that a payment is accepted by the contact payment terminal. For instance, the configurations shown in FIGS. 10 and 14 may be the most common configurations to swipe the back-up payment module through the contact payment terminal or otherwise establish contact between the back-up payment module and the contact payment terminal. As shown in FIG. 11, the back-up payment module shown in FIG. 10 may slide along the length LH of the housing in order to enable the user to more easily swipe the back-up payment module through a contact payment terminal. In some embodiments, the back-up payment module may even be able to slide across the entire length L1 of the mobile device even though the housing does not extend across the length of the mobile device. In another embodiment, the back-up payment module may be hinged to the mobile device at a single point or one or more discontiguous points along an edge L or W (e.g., intersection of L and W) of the back-up payment module. In another embodiment, the back-up payment module may be hinged to the mobile device at a single point (or one or more contiguous or discontiguous points) along the edges (L1 and W1 in FIG. 10) of the mobile device. In another embodiment, a point (or one or more contiguous or discontiguous points) anywhere in the body or on the surface of the back-up payment module may be hinged to a point (or one or more contiguous or discontiguous points) anywhere in the body or on the surface of the mobile device.

In one embodiment, a user may be able to slide the back-up payment module out of the housing a sliding mechanism. In most instances, the back-up payment module slides out of the longer edge of the housing (FIG. 10). In such an embodiment, a user may have to press the housing or press the back-up payment module to push it out of the housing. In an alternate embodiment, a may press a button on the mobile device, whereby pressing the button initiates either an electronic (or electromagnetic) mechanism in conjunction with a mechanical mechanism or a purely mechanical mechanism that automatically releases the back-up payment module from the housing. In some embodiments, the mechanism not only automatically releases the back-up payment module from the housing, but also automatically o.3rients the back-up payment module so that a user may easily establish physical contact between the back-up payment module and the contact payment terminal. In another embodiment, a user may have to open the housing, and subsequently, the back-up payment module may be released using a springing mechanism. In some embodiments (not shown), the back-up payment module may slide out of the shorter edge WH of the housing (see FIG. 13 as an example). Once the back-up payment module slides out of the housing, it can be oriented accordingly (e.g., FIG. 14) in order to swipe it through or establish contact with the contact payment terminal.

In one embodiment, the back-up payment module is not attached to the housing 494 or to the mobile device. In such an embodiment, the back-up payment module is separable or detachable from the housing or the mobile device. This back-up payment module is a stand-alone piece that may be received into the housing as shown in FIG. 13. When a user wants to make a payment using the back-up payment module, the user can completely release the back-up payment module from the housing and subsequently swipe or otherwise establish physical contact between the back-up payment module and a contact payment terminal.

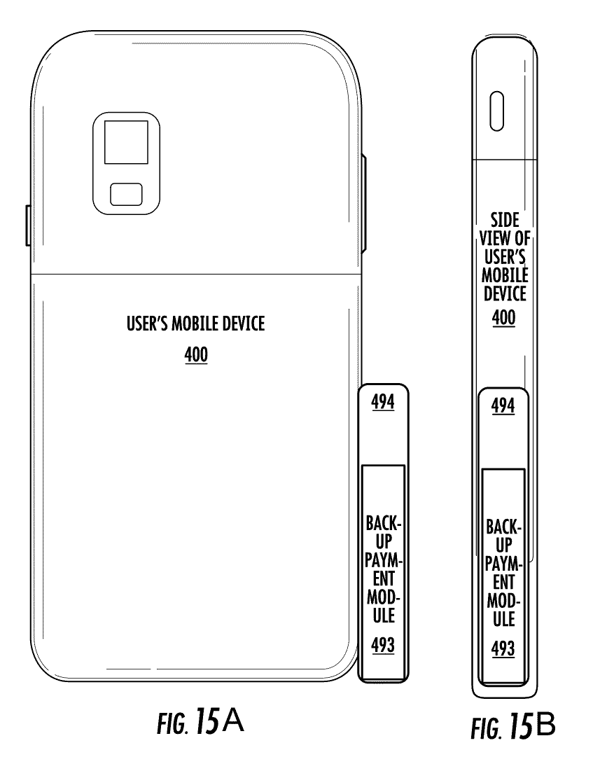

FIG. 15A shown an embodiment of the mobile device where the housing 494 is situated outside the mobile device. The back-up payment module is situated inside the housing similar to the previous embodiments and may be released from the housing the release mechanisms described with respect to the previous embodiments. In one embodiment of FIG. 15A, the back-up payment module may be released from the longer edge of the housing, wherein the release mechanism has been described earlier. Alternatively, in other embodiments of FIG. 15A, the back-up payment module may also be released from the either of the two shorter edges of the housing. Again, the release mechanism for releasing the back-up payment module from the shorter edges is similar to the release mechanism for releasing the back-up payment module from longer edge. Alternatively, in other embodiments as shown in FIG. 15B, the back-up payment module or the housing is hinged along a longer edge, or at one more dicontinguous points along the longer edge, to the mobile device. When the back-up payment module is not being used, it can be folded as shown in the side view of the user's mobile device. When the back-up payment module needs to be used, it can be rotated in a perpendicular manner about the hinged longer edge in order to be able to swipe the back-up payment module through, or otherwise make contact with, a contact payment terminal.

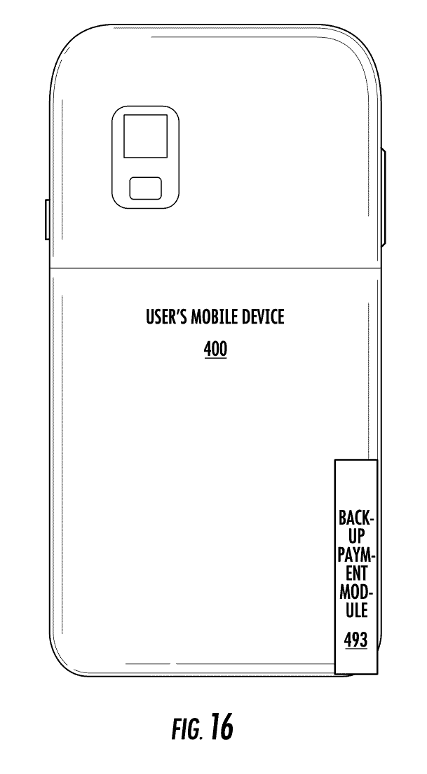

FIG. 16 shown an embodiment of the mobile device where the back-up payment module is situated directly in the mobile device. In this embodiment, there is no housing that houses the back-up payment module. The back-up payment module is hinged to and releasable from the mobile device in a similar manner to the embodiments where the back-up payment module is hinged to and releasable from the housing in a mobile device.

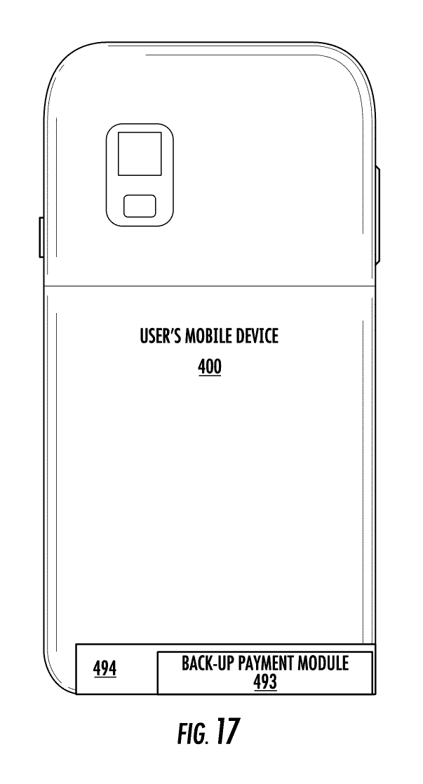

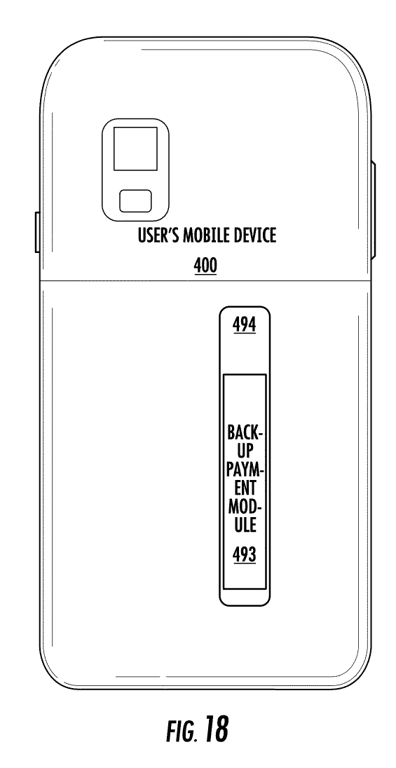

FIGS. 17 and 18 show embodiments of the mobile device where the housing is situated in different areas of the mobile device. As shown in the embodiments described herein, the housing or the back-up payment module may be situated anywhere within the mobile device or may even be situated outside the mobile device. In some embodiments, the housing or the back-up payment module may even be detachably hinged to the mobile device such that a user may remove the housing or the back-up payment module from one mobile device and hinge it to another mobile device.

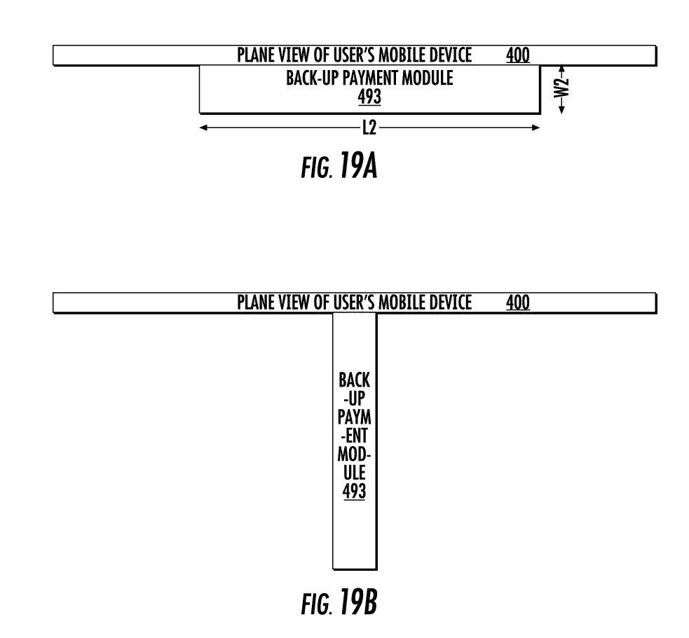

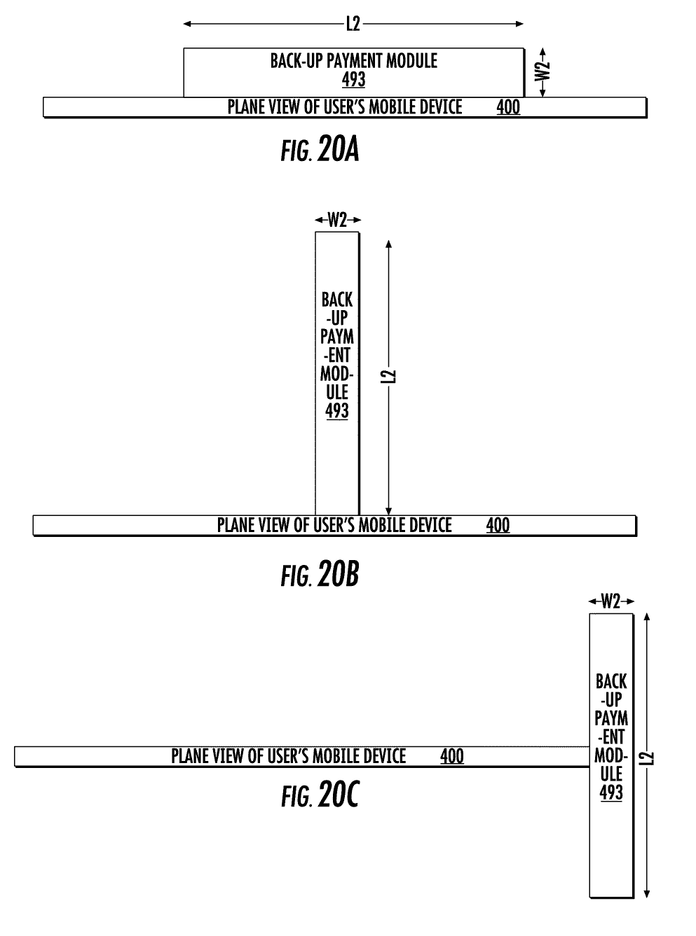

As shown in FIGS. 19 and 20, in any of the above embodiments, the back-up payment module, when released from the housing in the mobile device, may even be rotated and configured or oriented so that it is perpendicular to the plane of the mobile device (either L2 or W2 may be perpendicular to the plane of the mobile device). The permitted angle or degree of rotation may be limited by the hinge that hinges the back-up payment module with the housing or the mobile device. FIG. 19A presents an embodiment where the back-up payment module is released from the bottom plane of the mobile device and the shorter edge W2 of the back-up payment module is perpendicular to the bottom plane of the mobile device. In this embodiment, the longer edge L2 of the back-up payment module may point in the same direction as the longer edge of the bottom plane of the mobile device, or a shorter edge of the bottom plane of the bottom plane of the mobile device, or even a diagonal axis along the bottom plane of the mobile device. As shown in another embodiment by FIG. 19B, the back-up payment module may, after being released from the housing in the mobile device, be rotated such that a longer edge L2 of the back-up payment module is perpendicular to the bottom plane of the mobile device.

FIG. 20A presents an embodiment where the back-up payment module is released from the top plane of the mobile device and the shorter edge W2 of the back-up payment module is perpendicular to the top plane of the mobile device. In this embodiment, the longer edge L2 of the back-up payment module may point in the same direction as the longer edge of the top plane of the mobile device, or a shorter edge of the top plane of the mobile device, or even a diagonal axis along the top plane of the mobile device. As shown in another embodiment by FIG. 20B, the back-up payment module may, after being released from the housing in the mobile device, be rotated such that a longer edge L2 of the back-up payment module is perpendicular to the top plane of the mobile device.

FIG. 20C also shows another configuration where the back-up payment module is moved and rotated such that the longer edge L2 of the back-up payment module is perpendicular to an axis drawn through a plane of the mobile device, and wherein a portion of the back-up payment module extends above both the top and bottom planes of the mobile device.

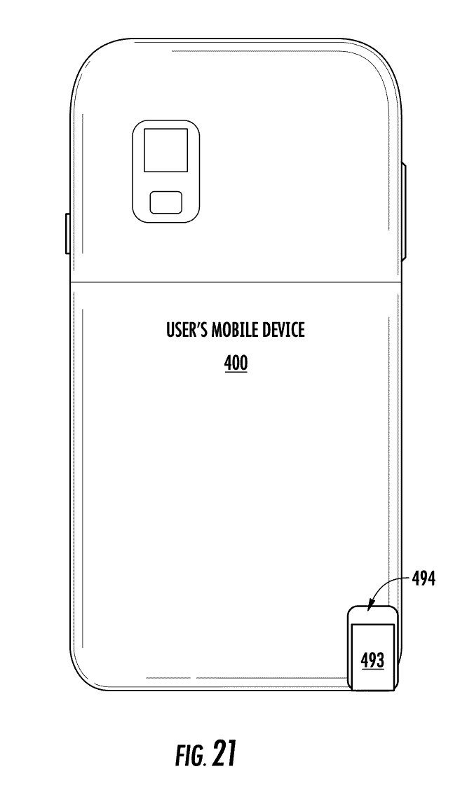

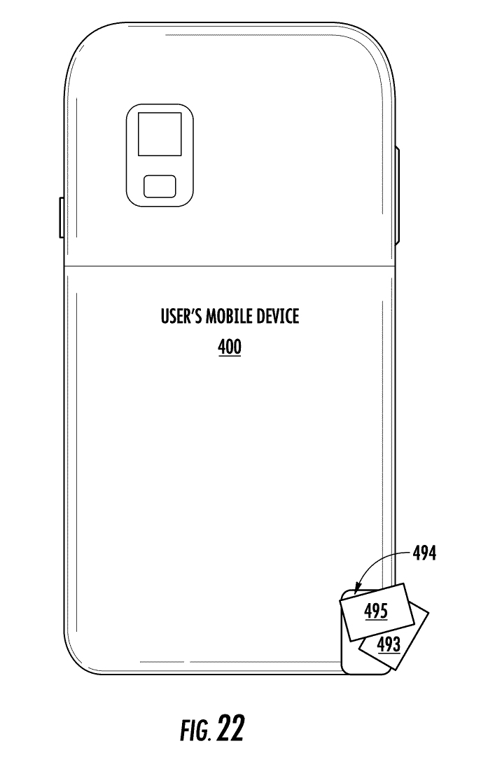

FIGS. 21-24 show embodiments where the dimensions of the housing 494 are smaller than the dimensions of the back-up payment module. In such embodiments, the back-up payment module may be folded or may be collapsed into two or more parts (e.g., 493, 495) so that the parts of the payment module can be stacked and fit into the housing. As shown in FIG. 22-24, when the stacked parts are released from the housing, the parts can be rearranged or reconfigured in order to reconstruct the back-up payment module. The parts may be released from the housing any of the release mechanisms described above. Although the embodiment shown in FIGS. 22-24 has only two parts, other embodiments may have more than two parts that form the back-up payment module. Although FIG. 22 shows that the parts or portions of the back-up payment module are hinged together at a single point, in other embodiments, the back-up payment module parts may be hinged in other ways, e.g., hinged along an entire edge of a part or hinged along two or more discontiguous points along an edge. In some embodiments, a entire or partial surface of one part is hinged to an entire or partial surface of another part. Alternatively, a point (or one or more contiguous or discontiguous points) on the surface of one part may be hinged to a point (or one or more contiguous or discontiguous points) on the surface of another part. The mechanism for hinging one part to another part may be similar to the hinging mechanisms described earlier with respect to hinging the back-up payment module to the mobile device. In today's world where mobile device are becoming smaller and smaller, the embodiment shown in FIGS. 21-24 helps to save space on the mobile device for carrying a back-up payment module, which in some instances is a back-up payment module that comprises one or more magnetic stripes.

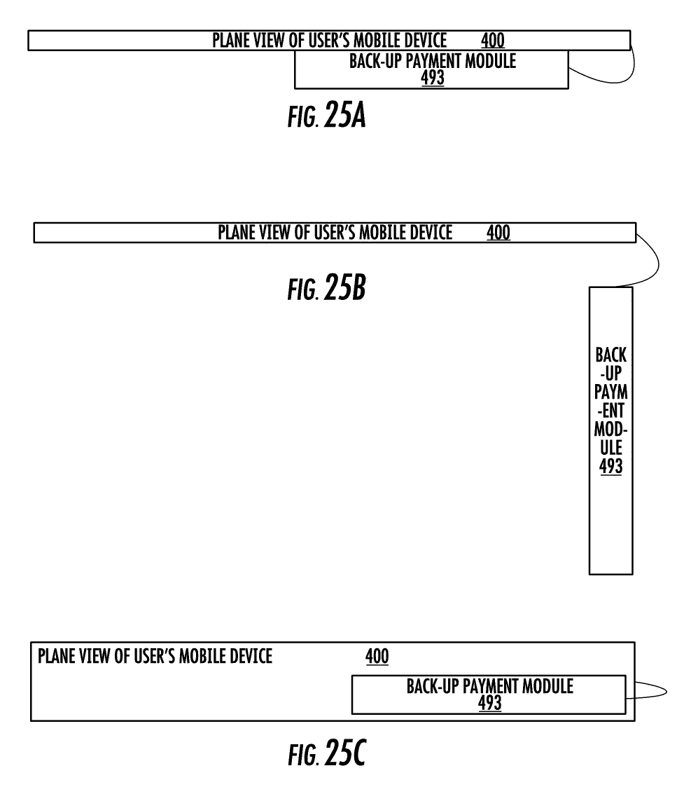

FIG. 25 shows another embodiment where the back-up payment module is coupled to the mobile device via a coupling mechanism, but is not necessarily directly attached or hinged to the mobile device. The coupling mechanism presented in FIG. 25 comprises a thread or a rope, but other embodiments may implement other coupling mechanisms instead of, or in addition to, the thread or rope. Therefore, as shown in FIG. 25B, in one configuration, the back-up payment module is hanging from the user's mobile device. For the embodiment presented in FIG. 25A, the back-up payment module may be detachably hinged to the surface of the mobile device so that it is not always hanging from the mobile device. Although FIG. 25A shows that that the back-up payment module is detachably hinged to an exterior surface of the mobile device, in some embodiments as depicted in FIG. 25C, the back-up payment module may be detachably inserted into the mobile device so that there is no outward projection of the back-up payment module from the surface of the mobile device.

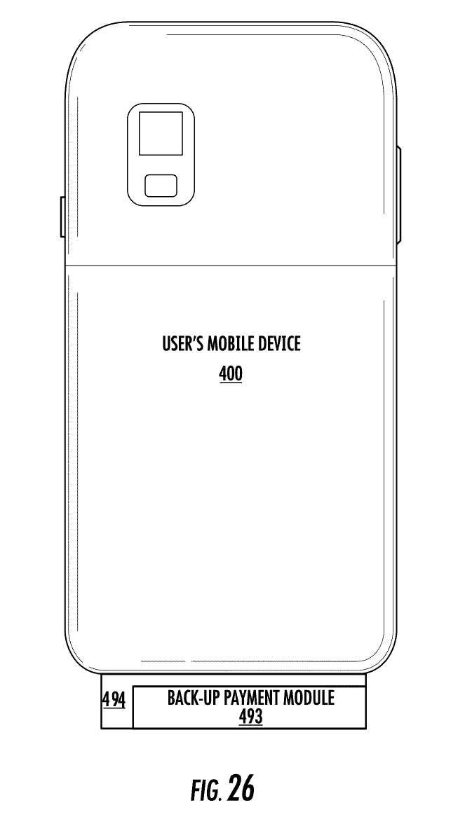

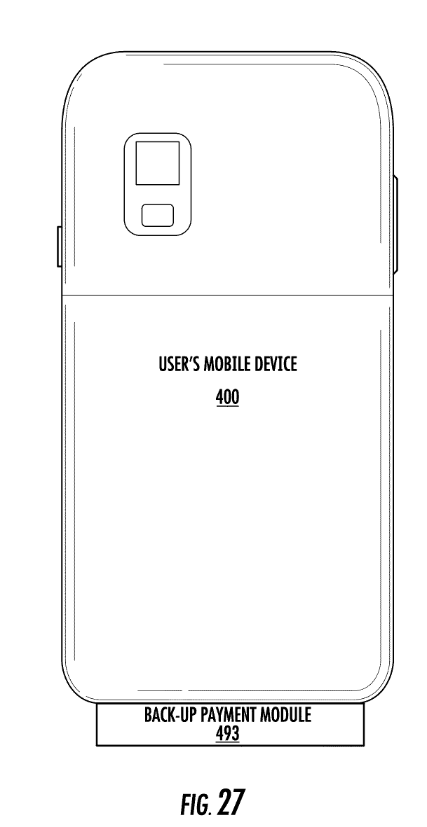

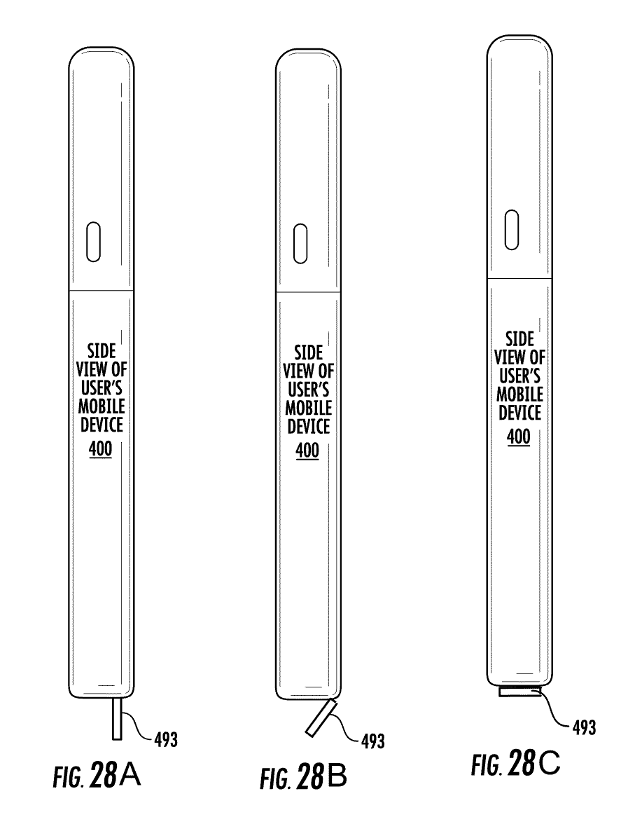

FIG. 26 displays an embodiment where the housing 494 runs along the entire length of the shorter edge of the mobile device. This housing comprises the back-up payment module. FIG. 27 displays an embodiment where the back-up payment module runs along the entire length of the shorter edge of the mobile device. These configurations may be more user-friendly in terms of a user being able to swipe the back-up payment through a contact payment terminal. In the embodiment displayed in FIG. 26, a user may only need to release the back-up payment module from the housing, and may not need to configure or rotate the back-up payment module in order to swipe the back-up payment module through a contact payment terminal. In the embodiment displayed in FIG. 27, a user does not even need to release, orient, configure, or rotate the back-up payment module, and may just directly swipe the back-up payment module through a contact payment terminal. In FIG. 27, the back-up payment module is immovable. Similarly, as shown in FIG. 28A (which presents the side-view of FIG. 27), a user may directly swipe the back-up payment module through a contact payment terminal. In one embodiment, it must be remembered that since the payment module displayed in FIG. 28 is always exposed, it may break or bend easily; therefore, the back-up payment module may need to be manufactured out of a sturdy material to prevent it from breaking or bending. Also, since the surfaces of the back-up payment module in FIGS. 27 and 28 are always exposed, the magnetic stripe may need to be shielded in such a manner that the magnetic stripe does not lose its magnetic properties over a period of time. Alternatively, in other embodiments of FIGS. 27 and 28, the back-up payment module or the housing is hinged along a longer edge, or at one more dicontinguous points along the longer edge, to the mobile device (see FIGS. 28A, 28B, and 28C). When the back-up payment module is not being used, it can be folded as shown in the side view of the user's mobile device. When the back-up payment module needs to be used, it can be rotated in a perpendicular manner about the hinged longer edge in order to be able to swipe the back-up payment module through, or otherwise make contact with, a contact payment terminal.

### Back-Up Payment Routine

### Back-Up Payment Module Comprising a Single Payment Vehicle

In one embodiment, the back-up payment module comprises a magnetic stripe that comprises payment information for a single payment vehicle. When this back-up payment module is swiped through, or otherwise makes contact with, a contact payment terminal (block 130 of FIG. 1), the contact payment terminal receives, reads, and processes payment vehicle data pertaining to the payment vehicle (see blocks 140 and 150 of FIG. 1).

In one embodiment, reading and processing the payment vehicle data (blocks 140 and 150 of FIG. 1) may comprise the payment terminal identifying the payment vehicle data packet by identifying the protocol associated with the payment vehicle data packet. For instance, if the received payment vehicle data packet protocol is identified as “ExpressPay” protocol, the received payment vehicle data is “Credit Card 1” payment vehicle data. If the received payment vehicle data packet protocol is identified as “payWave” protocol, the received payment vehicle data is “Credit Card 2” payment vehicle data. If the received payment vehicle data packet protocol is identified as “PayPass” protocol, the received payment vehicle data is “Credit Card 3” payment vehicle data. If the received payment vehicle data packet protocol is identified as “MIFARE” protocol, the received payment vehicle data may be gift card data.

Subsequently, the payment terminal may determine whether the payment vehicle data constitutes a valid payment vehicle (also part of blocks 140 and 150 of FIG. 1). The rules that define whether the payment vehicle data constitutes a valid payment vehicle may be set by the entity from which the user makes a purchase. For instance, the algorithm that defines the payment vehicle validation process may comprise determining whether the payment vehicle has expired, whether the payment vehicle is accepted by the entity, whether the payment vehicle may be used for this purchase, or the like.

If the payment terminal determines that the payment vehicle data is not valid, the payment terminal may generate and present a message to the user. In an embodiment, the payment terminal may also present the reason why the payment vehicle is not an accepted form of payment. In an embodiment, the payment terminal may also allow the user to attempt the transaction with another payment vehicle.

### Back-Up Payment Routine

### Back-Up Payment Module Comprising Multiple Payment Vehicles

In one embodiment, the back-up payment module may comprise payment data for one or more payment vehicles. In such an embodiment, when the back-up payment module is swiped through, or otherwise makes contact with, a contact payment terminal (block 130 of FIG. 1), the contact payment terminal receives, reads, and processes payment vehicle data (blocks 140 and 150 of FIG. 1) pertaining to payment vehicle that has been previously selected by the user as a default payment vehicle. The reading and processing (blocks 140 and 150 of FIG. 1) of payment vehicle data have been described previously. In one embodiment, a user may not be able to change the payment vehicle that is designated as the default payment vehicle. However, as explained below, in other embodiments, a user may be able to change the payment vehicle that is designated as the default payment vehicle.

As described previously, FIG. 2 displays an illustration of a look-up table 200 that is associated with the mobile wallet chip. However, in some embodiments, this table may also be stored in the back-up payment module (i.e., stored by the magnetic stripe). In some embodiments, this table may be stored in a secure module (similar to the previously described secure module stored in the mobile wallet chip) that is part of the back-up payment module. As displayed in FIG. 2, the look-up table comprises payment vehicle data regarding each payment vehicle that may be used at a payment terminal. The payment vehicle data for each payment vehicle may include the payment vehicle type, the payment vehicle number, the name associated with the payment vehicle, the expiration date of the payment vehicle, the security code associated with the payment vehicle, whether the payment vehicle is a credit or debit payment vehicle, etc. Also as displayed in FIG. 2, the look-up table may indicate the payment vehicle that has been selected as the default payment vehicle 210. Also as displayed in FIG. 2, in some embodiments, there may only be a single default payment vehicle that may be selected by the user. In one embodiment, there may more than one default payment vehicle selected by the user. In another embodiment, a user may establish a hierarchy of payment vehicles to serve as the default payment vehicle. In such an embodiment, the user may establish a ranking for the payment vehicles in the look-up table. In such an embodiment, the highest ranked payment vehicle may serve as the default payment vehicle when the back-up payment routine is executed via a back-up payment module of a mobile device.

In an embodiment where the user may be allowed to change the payment vehicle that is designated as the default payment vehicle, the user may select a radio button, or the like, for a different payment vehicle in order to change the default payment vehicle. In one embodiment where the look-up table is stored in the back-up payment module, the look-up table may be accessed via the user's mobile device's mobile wallet application GUI while a power source in the mobile device is present and active. When the user changes the default payment vehicle, the change is directly made in the look-up table.

In one embodiment, the above described look-up table may not be stored in the back-up payment module. In this embodiment, the look-up table is stored in a remote server and may be accessed via a network such as the Internet on a personal computer, a mobile device, some other computing platform or the like. Therefore, in this embodiment, the look-up table need not be accessed via the mobile device that comprises the back-up payment module. In this embodiment, when the user changes the default payment vehicle, the change is directly made in the look-up table that is stored at the remote server.

In an embodiment where the look-up table is stored in a remote server, in lieu of allowing payment vehicle data associated with the default payment vehicle to be transmitted, the mobile device may allow an identifier or the like, associated with the back-up payment module, to be transmitted (block 135 of FIG. 1) when the user swipes a magnetic stripe through a contact payment terminal. In an embodiment, this identifier is a unique identifier that identifies the back-up payment module associated with the user's mobile device. This unique identifier is also associated with the look-up table that is stored in a remote server. In one embodiment the identifier is a numeric code, alphanumeric code, hexadecimal code, binary code, or the like. Once the contact payment terminal receives this identifier, the rest of the process flow is identical to the process flow depicted in FIG. 1 (blocks 142, 144, 146, and 150) and described above with respect to the passive module of the mobile device, and described below briefly as well.

In an embodiment where the mobile device transmits an identifier associated with the back-up payment module rather than a payment vehicle data packet, the process moves from block 135 to block 142 of FIG. 1 where the payment terminal receives an identifier associated with the back-up payment module. In one embodiment, the back-up payment module may transmit the identifier in a data packet format that is readable and processable by the contact payment terminal. For the data packet to be readable and processable by the payment terminal, the data packet must be associated with a data protocol that is readable and processable by the payment terminal.

In one embodiment, the contact payment terminal may indicate that it has received the identifier by producing an audible beep. In another embodiment, the contact payment terminal may indicate that it has received the identifier by changing the color associated with one or more light emitting diodes (LEDs) that are situated on the payment terminal or by switching one or more LEDs from an “off” state to an “on” state. The method by which the contact payment terminal may indicate that it has received the identifier is not limited to these embodiments. In one embodiment, the contact payment terminal may not indicate, at all, that it has received the identifier.

Subsequently, in one embodiment, the contact payment terminal (or a remote computing system networked with the contact payment terminal) may, at block 144 of FIG. 1, identify the back-up payment module associated with the identifier by accessing a table of identifiers that is stored in a remote server. Subsequently, the contact payment terminal may access the look-up table associated with the identified back-up payment module. Subsequently, the contact payment terminal may, at block 146 of FIG. 1, identify from the look-up table the default payment vehicle selected by the user by accessing the previously described look-up table that is stored in a remote server.

Subsequently, at block 150 of FIG. 1, the contact payment terminal may determine whether the payment vehicle data constitutes a valid payment vehicle. The rules that define whether the payment vehicle data constitutes a valid payment vehicle may be set by the entity from which the user makes a purchase. For instance, the algorithm that defines the payment vehicle validation process may comprise determining whether the payment vehicle has expired, whether the payment vehicle is accepted by the entity, whether the payment vehicle may be used for this purchase, or the like.

If the payment terminal determines that the payment vehicle data is not valid, the payment terminal may generate and present, via a display associated with the contact payment terminal, a message to the user. In an embodiment, the payment terminal may also present, via a display, the reason why the payment vehicle is not an accepted form of payment. In an embodiment, the contact payment terminal may ask the user, via a display, whether the user would like to complete the transaction with another payment vehicle that is in the look-up table which is stored in a remote server. Subsequently, the contact payment terminal via allow the user to select, via a display associated with the contact payment terminal, an alternate payment vehicle that is stored in the look-up table.

### Processing of Payment Vehicle Data

When a user attempts to pay via any of the above-described payment routines, if the contact payment terminal determines that the identified payment vehicle data is valid, the contact payment terminal may process the payment vehicle data at block 150 of FIG. 1. In one embodiment, processing the payment vehicle data may comprise transmitting the payment vehicle data to a processing system from where the payment vehicle data may be routed to the entity's processing financial institution for authorization of payment vehicle data, capture of electronic funds from the source authorized by the payment vehicle, and deposit of electronic funds into a destination account specified by the entity. In some embodiments, the processing system may prompt the contact payment terminal to request the user to authorize payment via the payment vehicle, e.g., requesting the user for a digital signature on a touchpad associated with the contact payment terminal, on an electronic receipt, on a paper receipt, or the like. In some embodiments, the processing system may prompt the contact payment terminal to request the user to authorize payment via the payment vehicle if the payment amount is above a certain threshold amount.

### Other Devices/Systems in the Contact Payment Environment

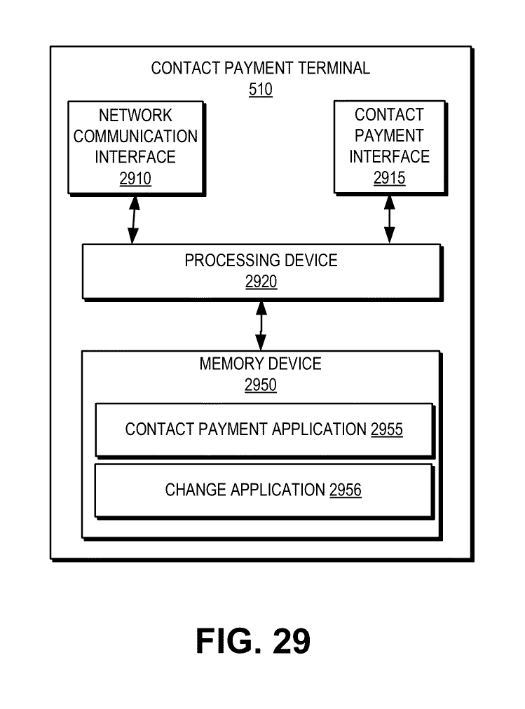

FIG. 29 displays an embodiment of a contact payment terminal 510 or the back-up payment module change terminal 516 that is displayed in FIG. 3. While the contact payment terminal 510 may just have the capability to read data from a back-up payment module, the change terminal 516 may have the capability to both read data from and write data to the back-up payment module of a mobile device. The contact payment terminal 510 (or the change terminal 516) may include various features, such as a network communication interface 2910, a processing device 2920, a contact payment interface 2915, and a memory device 2950 that may include a contact payment application 2955 and/or a change application 2956. In the contact payment environment, the user may make a payment by establishing physical contact between the back-up payment module of the mobile device and the contact payment terminal.

As used with respect to the contact payment terminal 510 (or the change terminal 516), a “communication interface” may generally include a modem, server, transceiver, and/or other device for communicating with other devices on a network. The network communication interface may be a communication interface having one or more communication devices configured to communicate with one or more other devices in the payment environment 300, such as the mobile device 400, the workstation 550, the processing system 600, other processing systems, data systems, etc. An embodiment of the workstation has been described previously.

In one embodiment, the contact payment interface 2915 is a separate module that may generally include a receiver and/or other electronic circuitry, devices, and software, for receiving electronic payment vehicle data when the back-up payment module of the mobile device establishes physical contact with the contact payment terminal (or the change terminal 516). In one embodiment, the receiver is a thin slot in the contact payment terminal 510 or the change terminal 516 through which the back-up payment module may be swiped. Data received by the processing device 2920 may be used to execute the various process blocks of the contact payment terminal, as described above with respect to FIG. 1. In other embodiments, the contact payment interface 2915 is part of the network communication interface 2910. In some embodiments of the change terminal 516, the contact payment interface 2915 may also be used as an interface to write data to the back-up payment module when the back-up payment module establishes physical contact with the change terminal 516. The power required to write data is supplied by the change terminal 516. The data to be written to the back-up payment module may be transmitted to the change terminal 516 via a computing device that allows a user to input data and that is in network communication with the change terminal 516.

An output device for the contact payment interface 2915 may include a display that provides instructions regarding the steps for making a contact payment via a back-up payment module of a mobile device. In some embodiments where the payment terminal requests the user's signature, the display may also serve as a touchpad input device to input the user's signature via a stylus. Other output devices may include one or more LEDs or an audio speaker, both which may indicate to the user that data has been successfully read from or written to the back-up payment module of a mobile device 400. A printer that can print paper receipts may also be incorporated into the contact payment terminal. Other embodiments of the contact payment terminal may carry other input and output devices, such as a mouse, keyboard, button, touchpad, touch screen, microphone, speaker, light, joystick, switch, or the like.

As used with respect to the contact payment terminal 510 (or the change terminal 516), a “processing device,” such as the processing device 2920, may generally refer to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system may be allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 2920 may be configured to use the network communication interface 2910 and/or the contact payment interface 2915 to write and/or read data from the back-up payment module and send/receive commands to and/or from the other devices that are visible in the payment environment 300.

As used with respect to the contact payment terminal 510 (or the change terminal 516), a “memory device” may generally refer to a device or combination of devices that store one or more forms of computer-readable media for storing data and/or computer-executable program code/instructions. For example, in one embodiment, the memory device may include any computer memory that provides an actual or virtual space to temporarily or permanently store data and/or commands provided to the processing device when it carries out its functions described herein. In one embodiment, the memory device stores a contact payment application 2955 and/or a change application 2956. The contact payment application 2955 may work in conjunction with the previously described contact payment interface 2915 to receive electronic payment vehicle data when the back-up payment module makes physical contact with the contact payment terminal. In some embodiments, the change application 2956 may be configured to write data to the back-up payment module when the back-up payment module establishes physical contact with the change terminal 516.

### Back-Up Payment System and Routine

### Code Payment Module

In some embodiments of FIGS. 8-28, the back-up payment module comprises one or more barcodes rather than one or more magnetic stripes. In such embodiments, the payment terminal comprises a barcode scanner. In FIG. 8, the barcode payment module 493 may be housed in the housing 494, in which case, the barcode payment module will need to be released from the housing to make a payment (at a barcode scanner that is present at a cashier's terminal). In other embodiments, the barcode may be printed on an outer surface of the mobile device. In such embodiments, the barcode will have to be printed using technology such that the barcode does not fade away over a period of time. In other embodiments, the barcode may be a label or sticker that is detachably/removably affixed onto the barcode payment module, or onto an outer or inner surface of the mobile device. In some embodiments, the barcode sticker may be attached and detached from the mobile device by a user. In some embodiments, this barcode sticker may not necessarily be attached to the back-up payment module, but may instead by attached and detached from other parts of the mobile device. In still other embodiments, a barcode that corresponds to a payment vehicle selected by a user is generated on a display associated with the mobile device by an application associated with the mobile device.

As used herein, the barcode may simply be a code that can be scanned by an appropriate scanner. The code may comprise alphanumeric characters, symbols, graphics, or any combination thereof, and can be scanned by a scanner that can subsequently forward the scanned information to a payment terminal.

When a user wishes to pay via the barcode sticker or label, the user allows a barcode scanner to scan the barcode sticker (similar to block 130 of FIG. 1), i.e., allows a barcode scanner to read payment vehicle data that corresponds with the barcode. Subsequently, the barcode scanner receives, reads, and processes payment vehicle data pertaining to the payment vehicle represented by the barcode (similar to blocks 140 and 150 of FIG. 1). In some embodiments, the barcode scanner forwards the payment vehicle data to a processing device which reads and processes the payment vehicle data pertaining to the payment vehicle.

In some embodiments, the barcode represents a unique identifier associated with the user or the user's mobile device. This unique identifier is also associated with a look-up table that is stored in a remote server (similar to FIG. 2 described above with respect to the passive module and with respect to the back-up payment module comprising a magnetic stripe). In one embodiment the identifier is a numeric code, alphanumeric code, hexadecimal code, binary code, or the like. Once the code payment terminal receives this identifier, the rest of the process flow is identical to the process flow depicted in FIG. 1 (blocks 142, 144, 146, and 150) and described above with respect to the passive module of the mobile device and the back-up payment module comprising a magnetic stripe.

In some embodiment, a barcode may be dynamically created on a display associated with the mobile device. In such an embodiment, a software application on a mobile device may allow a user to select a payment vehicle. In one embodiment, one or more payment vehicles may be stored in a secure module, which may directly be stored in the mobile device or which may be stored in a chip in the mobile device. Embodiments of the secure module have been described previously. When the user selects a payment vehicle, the application creates a unique barcode associated with the selected payment vehicle on a display associated with the mobile device. In one embodiment, a barcode is dynamically generated such that a barcode presented for a payment vehicle on one occasion may be different from the barcode presented for the same payment vehicle on another occasion. A user may then allow a barcode scanner to scan this barcode displayed on the user's mobile device (block 130 of FIG. 1). In such an embodiment, the process flow then moves to blocks 140 and 150 which have been described previously with respect to embodiments of the passive payment routine and with respect to other back-up payment routines.

This embodiment of the back-up payment module requires a power source in order to generate a barcode and present the barcode on a display with a mobile device, but is still useful when a contactless NFC payment option may not be active or may not be available as a form of payment.

### Other Devices/Systems in the Code Payment Environment

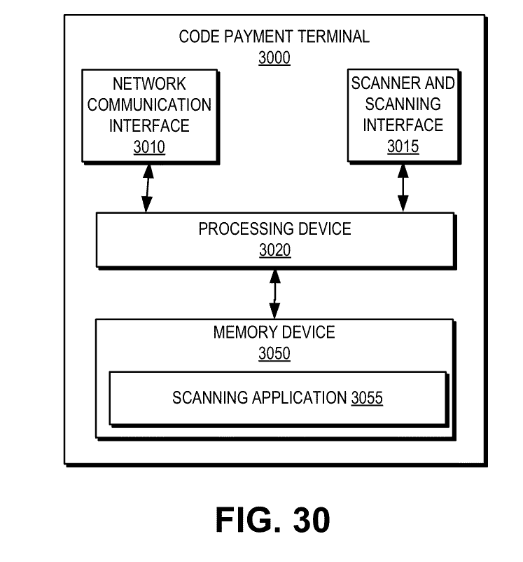

FIG. 30 displays an embodiment of a code payment terminal 3000. The code payment terminal 3000 may include various features, such as a network communication interface 3010, a processing device 3020, a scanner and scanning interface 3015, and a memory device 3050 that may include a scanning application 3055. In the payment environment, the user may make a payment by allowing the scanner 3015 to scan a code from the user's mobile device.

As used with respect to the code payment terminal 3000, a “communication interface” may generally include a modem, server, transceiver, and/or other device for communicating with other devices on a network. The network communication interface 3010 may be a communication interface having one or more communication devices configured to communicate with one or more other devices in the payment environment 300, such as the mobile device 400, the workstation 550, the processing system 600, other processing systems, data systems, etc. An embodiment of the workstation has been described previously.

In one embodiment, the scanner 3015 is a separate module that may generally include a scanning interface and/or other electronic circuitry, devices, and software, for reading electronic data associated with a code. Data received by the processing device 3020 may be used to execute the various process blocks of the code payment terminal, as described above with respect to FIG. 1. In other embodiments, the scanning interface 3015 is part of the network communication interface 3010.

An output device for the scanner and scanning interface 3015 may include a display that provides instructions regarding the steps for making a payment via a code associated with a user's mobile device. In some embodiments where the code payment terminal requests the user's signature, the display may also serve as a touchpad input device to input the user's signature via a stylus. Other output devices may include one or more LEDs or an audio speaker, both which may indicate to the user that data has been successfully read from a code associated with the user's mobile device 400. A printer that can print paper receipts may also be incorporated into the code payment terminal. Other embodiments of the code payment terminal may carry other input and output devices, such as a mouse, keyboard, button, touchpad, touch screen, microphone, speaker, light, joystick, switch, or the like.

As used with respect to the code payment terminal 3000, a “processing device,” such as the processing device 3020, may generally refer to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system may be allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 3020 may be configured to use the network communication interface 3010 and/or the scanner and scanning interface 3015 to read data associated with a code and send or receive commands to and/or from the other devices that are visible in the payment environment 300.

As used with respect to the code payment terminal 3000, a “memory device” may generally refer to a device or combination of devices that store one or more forms of computer-readable media for storing data and/or computer-executable program code/instructions. For example, in one embodiment, the memory device may include any computer memory that provides an actual or virtual space to temporarily or permanently store data and/or commands provided to the processing device when it carries out its functions described herein. In one embodiment, the memory device stores a scanning application 3055. The scanning application 3055 may work in conjunction with the previously described scanner and scanning interface 3015 to read electronic data associated with a code associated with a mobile device.

Thus, present embodiments of the invention disclosed in detail above provide systems, methods, and computer program products for making a payment at a contactless payment terminal via a mobile device, regardless of whether a power source in the mobile device is present or active, and for making a contact payment at a contact payment terminal, regardless of whether a power source in the mobile device is present or active. Other embodiments of the invention provide other systems, methods, and computer program products for making a payment (e.g., via a code payment module) at a payment terminal via a mobile device. As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” For example, various embodiments may take the form of web-implemented computer software. Furthermore, embodiments of the present invention may take the form of a computer program product on a computer-readable medium having computer-executable program code embodied in the medium.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein above with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A mobile apparatus for making a payment comprising:
a contact payment module movably attached to the mobile apparatus,
wherein the contact payment module is configured to execute a payment routine,
wherein the payment routine comprises necessarily establishing physical contact between the contact payment module and a payment terminal.

2. The mobile apparatus of claim 1, wherein the contact payment module is movably attached to the mobile apparatus via a hinge.

3. The mobile apparatus of claim 2, wherein the contact payment module can be moved along an axis permitted by the hinge.

4. The mobile apparatus of claim 2, wherein the contact payment module can be rotated about the hinge.

5. The mobile apparatus of claim 1, wherein the contact payment module is movably attached to the mobile apparatus via a pivot.

6. The mobile apparatus of claim 1, wherein establishing physical contact between the contact payment module and the payment terminal causes payment vehicle data associated with a payment vehicle to be transmitted to the payment terminal.

7. The mobile apparatus of claim 1, wherein establishing physical contact between the contact payment module and the payment terminal causes an identifier associated with the contact payment module is transmitted to the payment terminal.

8. The mobile apparatus of claim 1, wherein the contact payment module comprises a magnetic stripe that retains payment vehicle data for one or more payment vehicles.

9. The mobile apparatus of claim 1, wherein the contact payment module retains payment vehicle data for one or more payment vehicles, wherein a user designates one of the payment vehicles as a default payment vehicle.

10. The mobile apparatus of claim 9, further comprising a converter module, wherein the converter module allows a user to change a payment vehicle associated with the contact payment module from a first payment vehicle to a second payment vehicle.

11. The mobile apparatus of claim 1, wherein the contact payment module is activated when a power source is either not present in the mobile apparatus or not active.

12. The mobile apparatus of claim 1, wherein the contact payment module is received in a housing, wherein the housing is situated within the body of the mobile apparatus.

13. The mobile apparatus of claim 1, wherein the contact payment module is releasable from the housing, and wherein the contact payment module is detachable from the mobile apparatus.

14. The apparatus of claim 12, wherein, in order to receive the contact payment module into the mobile apparatus, the contact payment module is collapsed into a plurality of parts, wherein the plurality of parts need to be rearranged in order to make a payment via the contact payment module.

15. A mobile apparatus for making a payment comprising:
a memory comprising information about one or more payment vehicles stored therein;
a user interface configured to present information to a user;
a transmitter configured to wirelessly transmit information to a first apparatus;
a contactless payment module, executable by a processor, and configured to execute a contactless payment routine, wherein the contactless payment routine comprises:
transmitting to the first apparatus, using the transmitter, payment vehicle data associated with the selected payment vehicle; and
a contact payment module configured to execute a contact payment routine, wherein the contact payment routine comprises allowing payment vehicle data associated with a payment vehicle to be transmitted to a second apparatus when physical contact is established between the contact payment module and the second apparatus.

16. The apparatus of claim 15, wherein the contactless payment module is a near-field communication (NFC) device.

17. The apparatus of claim 15, wherein the contactless payment module is an active near-field communication (NFC) device.

18. The apparatus of claim 15, wherein the contactless payment module is a passive near-field communication (NFC) device.

19. The apparatus of claim 15, wherein the contact payment module comprises a magnetic stripe that retains payment vehicle data.

20. A method for making a payment via a mobile device comprising:
allowing a user to orient a contact payment module, wherein the contact payment module is connected to the mobile device; and
allowing a user to establish physical contact between the contact payment module and a payment terminal such that data is transmitted to the payment terminal only when a correctly oriented contact payment module establishes physical contact with the payment terminal.

21. The method of claim 20, wherein allowing a user to orient a contact payment module comprises:
allowing a user to release the contact payment module from the mobile device.

22. The method of claim 20, wherein allowing a user to orient a contact payment module comprises:
allowing a user to rotate the contact payment module about a hinge, wherein the degree of rotation is limited by the hinge, wherein the hinge connects the contact payment module with the mobile device.

23. The method of claim 20, wherein allowing a user to orient a contact payment module comprises:
allowing a user to move the contact payment module about an axis permitted by a hinge, wherein the hinge connects the contact payment module with the mobile device.

24. The method of claim 20, wherein allowing a user to orient a contact payment module comprises:
allowing a user to initiate an automated mechanism, wherein the automated mechanism causes the contact payment module to be automatically oriented for a user to establish physical contact between the contact payment module and the payment terminal.

25. A method for managing a contact payment module via a mobile device comprising:
allowing a user to select a payment vehicle via a user interface;
replacing a payment vehicle stored in the contact payment module with the selected payment vehicle;
wherein the contact payment module enables a user to make a payment when a user establishes physical contact between the contact payment module and a payment terminal.

26. The method of claim 25 wherein the contact payment module stores only one payment vehicle.

27. The method of claim 25 further comprising:
allowing a user to select a payment vehicle as a default payment vehicle;
wherein the contact payment module stores payment vehicle data associated with one or more payment vehicles.

28. The method of claim 27 further comprising:
allowing a user to add a payment vehicle to the contact payment module; and
allowing a user to delete a payment vehicle from the contact payment module.

29. A computer program product for managing a contact payment module via a mobile device, the computer program product comprising:
a non-transitory computer-readable medium comprising a set of codes for causing a computer to:
allow a user to select a payment vehicle via a user interface;
replace a payment vehicle stored in the contact payment module with the selected payment vehicle;
wherein the contact payment module enables a user to make a payment when a user establishes physical contact between the contact payment module and a payment terminal.

30. The computer program product of claim 29 wherein the set of codes further causes a computer to:
allow a user to select a payment vehicle as a default payment vehicle;
wherein the contact payment module stores payment vehicle data associated with one or more payment vehicles.

31. The computer program product of claim 29 wherein the set of codes further causes a computer to:
allow a user to add a payment vehicle to the contact payment module; and
allow a user to delete a payment vehicle from the contact payment module.

32. A mobile apparatus for making a payment comprising:
a user interface configured to present information to a user;
a code payment module configured to execute a payment routine;
wherein the payment routine comprises allowing a scanner to scan a code such that payment data is transmitted to a payment terminal.

33. The apparatus of claim 32, wherein the code is removably affixed to the mobile apparatus.

34. The apparatus of claim 32, further comprising:
a memory comprising information about one or more payment vehicles stored therein,
wherein the code is a unique code generated based on a payment vehicle selected by the user, and
wherein the code is presented on the user interface.

35. The apparatus of claim 34, wherein the code is dynamically generated such that a code generated for the selected payment vehicle on a first occasion is different from a code generated for the selected payment vehicle on a second occasion.

36. A mobile communication device comprising:
a user interface configured to present information to a user; and
a contact payment module attached to the mobile communication device,
wherein the contact payment module is configured to execute a payment routine, and
wherein the payment routine comprises necessarily establishing physical contact between the contact payment module and a payment terminal.

37. The mobile communication device of claim 36, wherein the contact payment module is received in a housing, wherein the housing is situated outside a body of the mobile communication device.

38. The mobile communication device of claim 36, wherein the contact payment module comprises a magnetic stripe that retains payment vehicle data for one or more payment vehicles.
